(19) United States
(12) Patent Application Publication
(10) Pub. No.: US 2019/0220497 A1
(43) Pub. Date: Jul. 18, 2019

(54) PHASE ARITHMETIC FOR QUANTUM COMPUTATION

(71) Applicant: Microsoft Technology Licensing, LLC, Redmond, WA (US)

(72) Inventors: Nathan O. Wiebe, Redmond, WA (US); Andras Pal Gilyen, Issaquah, WA (US)

(73) Assignee: Microsoft Technology Licensing, LLC, Redmond, WA (US)

(21) Appl. No.: 16/252,288

(22) Filed: Jan. 18, 2019

Related U.S. Application Data
(60) Provisional application No. 62/619,027, filed on Jan. 18, 2018.

(51) Int. Cl. G06F 17/12; G06N 10/00; G06F 17/14

(52) U.S. Cl. CPC G06F 17/12; G06F 17/14; G06N 10/00

(57) ABSTRACT

This application relates generally to quantum computing. In particular, this application discloses example tools and techniques for performing phase arithmetic in quantum computer environments. Embodiments of the disclosed technology allow one to multiply N phases within error ϵ using [symbol] (N² log(N/ϵ) log log(1/ϵ)) queries to the circuits that output the N constituent phases using [symbol] (N(log(N)+log log(1/ϵ))) ancillary qubits. Also disclosed are example applications of these techniques to synthesizing specific functions of phase and new error bounds for robust amplitude amplification that is quadratically better than the standard bound.

### CROSS-REFERENCE TO RELATED APPLICATIONS

This application claims the benefit of U.S. Provisional Application No. 62/619,027 entitled “PHASE ARITHMETIC FOR QUANTUM COMPUTATION” and filed on Jan. 18, 2018, which is incorporated herein by reference in their entirety.

### FIELD

This application relates generally to quantum computing. In particular, this application discloses example tools and techniques for performing phase arithmetic in quantum computer environments.

### SUMMARY

Generally speaking, two approaches are known for performing arithmetic using quantum computers which involve reversible logic and phase arithmetic. While phase arithmetic can require exponentially fewer logical qubits than reversible arithmetic, in some cases it requires super-polynomially more gates. In this disclosure, example methods for performing arithmetic in phase are disclosed that use linear combinations of unitaries to enact non-linear transformations in the phase.

Specifically, embodiments of the disclosed technology allow one to multiply N phases within error ϵ using [symbol] (N² log(N/ϵ) log log(1/ϵ)) queries to the circuits that output the N constituent phases using [symbol] (N(log(N)+log log(1/ϵ))) ancillary qubits. In contrast, previous approaches require [symbol] (log(1/ϵ)) ancillae or have complexity that is super-polylogarithmic in 1/ε. Also disclosed are example applications of these techniques to synthesizing specific functions of phase and new error bounds for robust amplitude amplification that is quadratically better than the standard bound.

In some embodiments, in a quantum computing device, phase arithmetic is performed using linear combinations of more than one unitaries; the result of the phase arithmetic from the quantum computing device is then read out. In certain implementations, the performing phase arithmetic is performed without using a repeat-until-success process or circuit. In further implementations, the phase arithmetic comprises a smooth multi-variable function. In some implementations, the phase arithmetic comprises a multiplication function of two phases. In certain implementations, the phase arithmetic comprises a multiplication function of a phase with a fixed real number. In further implementations, phase estimation is used to output the phase as a bit string. In some implementations, the function to be computed represents the classification output by a quantum neural network. In further implementations, the functions computed represent part of or the entirety of the kinetic or potential energy of a quantum system within a quantum simulation. The method can be performed by one or more computer-readable media storing computer-executable instructions, which when executed by a classical computer cause the classical computer to perform the method.

In further embodiments, the method is performed by a quantum computing system. In such embodiments, the quantum computing system, comprises a quantum computing device comprising a quantum circuit; and a classical computing device in communication with the quantum computing device and adapted to perform a method, the method comprising: performing phase arithmetic in the quantum computing device using linear combinations of more than one unitaries; and reading out the result of the phase arithmetic from the quantum computing device. In certain implementations, the performing phase arithmetic is performed without using a repeat-until-success process or circuit. In further implementations, the phase arithmetic comprises a smooth multi-variable function. In some implementations, the phase arithmetic comprises a multiplication function of two phases. In certain implementations, the phase arithmetic comprises a multiplication function of a phase with a fixed real number. In further implementations, phase estimation is used to output the phase as a bit string. In some implementations, the function to be computed represents the classification output by a quantum neural network. In further implementations, the functions computed represent part of or the entirety of the kinetic or potential energy of a quantum system within a quantum simulation.

In some embodiments, operations in a quantum computing device are performed by a method using (a) linear combinations of unitary methods to implement arithmetic functions, other than addition, of more than one variable in phase in the quantum computing device; (b) linear combinations of unitary methods to implement arithmetic functions over more than one variable in phase in the quantum computing device using Fourier series approximations; or (c) linear combination of unitary methods in the quantum computing device to implement a fractional query of a diagonal phase oracle which outputs a range of phases. In certain implementations, the method comprises using (a) or (b) to implement generic smooth functions of many variables in phase on quantum computers. Further, in some implementations, the method comprises using (c).

Any of the embodiments disclosed above can be implemented as part of a system comprising a quantum computing device comprising a quantum circuit; and a classical computing device in communication with the quantum computing device and adapted to perform any of the disclosed methods.

Any of the embodiments disclosed above can also be implemented by one or more computer-readable media storing computer-executable instructions, which when executed by a classical computer cause the classical computer to perform a method of controlling a quantum computing device according to any of the disclosed methods.

The foregoing and other objects, features, and advantages of the disclosed technology will become more apparent from the following detailed description, which proceeds with reference to the accompanying figures.

### BRIEF DESCRIPTION OF THE FIGURES

FIG. 1 is a diagram showing a geometric illustration of the parameters of the Grover operator G_{U}

FIG. 2 is a block diagram 200 showing a Hadamard test circuit where the probability of measuring |1 [symbol] is

$$\frac{1 + Re ( 〈 φ \vert W \vert φ 〉 )}{2} ,$$

for |ϕ [symbol] =V|0 [symbol] ^{⊗n}.

FIG. 3 is a schematic block diagram 300 showing a quantum circuit for implementing a Fourier series of H=log(U).

FIG. 4 is a flow chart showing an example method for performing a linear combination of unitaries.

FIG. 5 is a flow chart showing how linear combinations of unitary circuits (LCU) can be used for multiplication.

FIG. 6 is a flow chart showing an example method for computing the real part of the expectation value of a function.

FIG. 7 is a flow chart showing an example method for computing elementary trigonometric functions (using the method of FIG. 6) and outputting result as a phase.

FIG. 8 illustrates a generalized example of a suitable classical computing environment in which aspects of the described embodiments can be implemented.

FIG. 9 shows an example of a possible network topology (e.g., a client-server network) for implementing a system according to the disclosed technology.

FIG. 10 shows another example of a possible network topology (e.g., a distributed computing environment) for implementing a system according to the disclosed technology.

FIG. 11 shows an exemplary system for implementing the disclosed technology.

FIG. 12 is a flow chart showing a general method for performing embodiments of the disclosed technology.

FIG. 13 is a flow chart showing a further general method for performing embodiments of the disclosed technology.

### DETAILED DESCRIPTION

### I. General Considerations

As used in this application, the singular forms “a,” “an,” and “the” include the plural forms unless the context clearly dictates otherwise. Additionally, the term “includes” means “comprises.” Further, the term “coupled” does not exclude the presence of intermediate elements between the coupled items. Further, as used herein, the term “and/or” means any one item or combination of any items in the phrase.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

### II. Introduction

Since the discovery of quantum computing, a host of methods have been devised to perform arithmetic operations using quantum operations. While arithmetic is typically viewed as a primitive operation for ordinary computers, its implementation on a quantum computer often comes with large overheads due to the reversible implementation requirement. Binary computation in general can be made reversible by using a process known as the Bennett trick, which computes the result of the arithmetic out of place, therefore requiring new qubit registers for the output. While this does not substantially affect the time complexity of quantum arithmetic, it can have a substantial impact on the space complexity because intermediate results needed for a computation often cannot be efficiently uncomputed during a larger algorithm. Even in the case of some basic operations, such as the computation of the reciprocal, it can lead to an overhead of thousands of quantum bits. This alone can render such algorithms impractical for small fault-tolerant quantum computers.

Phase arithmetic was developed as a way to prevent this. The idea behind phase arithmetic is to store the values needed for a computation in phase, rather than in qubits. This encoding allows a single idealized logical qubit to store the input to infinite precision (in practice fault tolerant considerations render the ability of a single qubit to store only a finite precision number when using a finite distance code). In such cases, the input is not assumed to be bit strings but is given by phase angles of an oracle. For example, such an input oracle may map |j [symbol] [symbol] e^{ix}^{ⱼ}|j [symbol] for xⱼ∈[−1, 1] and the aim could be to perform |j, k [symbol] [symbol] e^{ix}^{ⱼ}^{x}^{ₖ}|j, k [symbol] within a fixed error tolerance using calls to the input oracle. The approach considered in the literature uses a gadget to build up the Taylor series of a function of several inputs in the phase using a gadgets known as generalized PAR and gearbox circuits. These gadgets allow one, using a measure and repeat-until-success scheme, to perform such arithmetic.

A notable issue with such approaches is that the success probability of the arithmetic step depends on the form of the state. This means that without modification the repeat-until-success circuits collapse the state in each application. This problem can be dealt with by using a time-slicing scheme to make the success probability near-uniform over all inputs and oblivious amplitude amplification, but with known constructions this renders the resources needed for the construction inverse-polynomial in the desired accuracy rather than sub-polynomial.

Here, example embodiments are disclosed that provide a method based on a linear-combination of unitaries that manifestly avoids the need to use repeat-until-success circuits to perform phase arithmetic. These example approaches, in some cases, use slightly more qubits than previous phase arithmetic approaches, but obtain poly-logarithmic scaling. Notably, embodiments of the disclosed methods allow one to perform entire algorithms within the LCU framework. Keeping the entire algorithm inside the LCU formalism means that less work is needed to recast the output of any quantum procedure that is used to perform the arithmetic which can lead to considerable improvements in certain algorithms.

### III. Phase Arithmetic

One can interpret the phase as a real number in (−π, π], therefore one can use it for representing numbers. In order to avoid “wrapping-around” one desirably restricts the range to a subinterval of (−π, π ]. Since very close phases are hard to distinguish, the range [−1, 1] is used, so that the minimal and the maximal phases are easy to distinguish. (In principle one could use a larger subinterval, but this choice is convenient for example purposes.)

Since global phases are irrelevant in quantum mechanics, the numbers are represented as relative phases. Inspired by many quantum algorithms, the phases are represented dynamically by unitaries rather than statically by some quantum state. Therefore the following input model is used:

### Definition 1 (Phase Input)

For a vector of real numbers \vec{x}∈[−1, 1]^{N} the (controlled) phase gate is defined as the unitary

$${P}_{\vec{x}} = \vert 0 〉 〈 0 \vert ⊗ {\sum }_{k = 1}^{N} \vert k 〉 〈 k \vert + \vert 1 〉 〈 1 \vert ⊗ {\sum }_{k = 1}^{N} \vert k 〉 〈 k \vert {e}^{{ix}_{k}} ∈ {ℂ}^{2 N \times 2 N} .$$

And a phase oracle is defined as the unitary

O_{\vec{x}}=P_{\vec{x}}⊗|0 [symbol] [symbol] 0|^{⊗a}+V,

where a∈ [symbol] is the number of ancilla qubits needed to implement the phase oracle and (I⊗|0 [symbol] [symbol] 0|^{⊗a})V=0. Õ_{\vec{x}} is called an ε-approximate phase oracle if it is ε-close (in spectral norm) to a phase input oracle O\vec{x}. When phase oracle access is assumed, access to its inverse is assumed as well.

Note that in the above definition P_{\vec{x}} differs from O_{\vec{x}} only in that the latter is allowed to act on an ancillary space that is initially set to zero and is promised to revert those qubits to |0 [symbol] ^{⊗a}. Similarly, the operator V can be dropped from the definition if one also wishes to have the action of the phase oracle only defined on ancillary qubits that are pre-initialized to zero.

The discussion below describes how to implement various arithmetic operations in phase, in the sense that it is shown how to implement the corresponding phase oracle by using the input phase oracles. The operations described might create phases that are out of the range [−1, 1]. But the procedures are only guaranteed to work when the input phases are in the range [−1, 1], so one needs to be careful when chaining operations.

In the following, particular attention is drawn to how to perform arithmetic operations using phase oracles. When one does the cost analysis, one can calculate the number of applications (or queries) of the input oracles O_{\vec{x}}, Qᵢⱼ and their inverses.

Fundamentally only two operations are needed to compute an arbitrary analytic function: addition and multiplication. So in order to show that the disclosed version of phase arithmetic can implement such a function, one needs to demonstrate the capability to perform both operations. The discussion below first shows how to perform addition, then focuses on performing multiplication between two phase inputs, and finally a generalization of this to the product of N phase inputs.

III.A. Addition

### Theorem 2

Suppose that \vec{x}ⱼ∈[−1, 1]^{N} for all j=1, . . . , D and one has access to the phase oracles O_{\vec{x}j} for j=1, . . . , D. The phase oracle O_{Σ}_{ⱼ}_{\vec{x}}_{ⱼ}, can be implemented using only queries D to these oracles and in general the query complexity of phase addition is in Ω(D) which implies that this protocol is asymptotically optimal in a blackbox setting.

### Proof.

The upper bound is trivial. Suppose that O_{\vec{x}} and O_{\vec{y}} are phase oracles, then

O_{\vec{x}+\vec{y}}=O_{\vec{x}}O_{\vec{y}}=O_{\vec{y}}O_{\vec{x}}.

Thus by recursing this process D times it is straight forward to see that

$${\prod }_{j = 1}^{D} {O}_{{\vec{x}}_{j}} = {O}_{{\sum }_{j = 1}^{D} {\vec{x}}_{j} ,}$$

thus addition can be performed using precisely D queries to these phase oracles.

Next one needs to show that one cannot perform such an addition using o(D) queries to these oracles. One can prove this by contradiction. Assume such a process existed then one could take x₁=x₂= . . . =x_{D}=x for the scalar case of N=1 and thus one can implement using such an adder O_{Dx} using o(D) queries to the oracle Oₓ. It is shown in Acin, Antonio, “Statistical distinguishability between unitary operations”, Physical review letters, vol. 87, no. 17, pg. 177901 (2001) that the minimal number of queries needed to unambiguously distinguish the phase oracles Oₓ from O₀ is π/[2x]. Similarly π/[2Dx] queries are needed to distinguish between O_{Dx} and O₀ unambiguously. If O_{Dx} is distinguished unambiguously from O₀ then Oₓ is unambiguously distinct from O₀ also since D≥1. Now if O_{Dx} can be implemented using o(D) queries to Oₓ then Oₓ can be distinguished from O₀ using o(D)[π/(2Dx)]∈o(1/x) queries. This is a contradiction and hence the query complexity of implementing O_{Dx} is in Ω(D). □

As mentioned above, addition is optimal for integer multiplication of a phase input. While this means that the development of customized methods for multiplying phases by numbers larger than 1 is largely unnecessary, addition does not provide a way to multiply the phase output by a phase oracle by a non-integer constant or for that matter the phase output by a second phase oracle. The following section addresses this point.

III.B Multiplication

III.B.1. Multiplying Two Phases

The main technical tool used to perform multiplications is a specialized version of the LCU Lemma for the case when all unitary is a power of some unitary U. See Lemma 4 of Dominic W. Berry et al., “Hamiltonian Simulation with Nearly Optimal Dependence on all Parameters,” IEEE 56th Annual Symposium on Foundations of Computer Science, pgs. 792-809 (2015); Lemma 8 of Andrew M. Childs et al., “Quantum linear systems algorithm with exponentially improved dependence on precision,” arxiv 1511.02306 (2015); and Joran van Apeldoorn et al., “Quantum SDP-Solvers: Better upper and lower bounds,” arxiv 1705.01843v1 (2017). Here, a version of the LCU Lemma tailored for the disclosed applications is described: (its proof can be found in the appendix)

### Lemma 3 (Fourier LCU Lemma)

Suppose that β∈ [symbol] ^{2M+1}, ∥β∥₁≤B∈ [symbol] ₊ and U: [symbol] → [symbol] is a unitary, moreover L=Σ_{m=-M}^{M}βₘU^{m}. Let b=┌log₂(M+2)┐, then one can implement a unitary circuit C such that for all |ψ [symbol] ∈ [symbol] it acts as

$$C : \vert ψ 〉 {\vert 0 〉}^{⊗ a} \to \frac{L}{B} \vert ψ 〉 {\vert 0 〉}^{⊗ a} + γ \vert {Φ}^{⊥} 〉 , where ( I ⊗ \vert 0 〉 〈 0 {\vert}^{⊗ a} ) \vert {Φ}^{⊥} 〉 = 0 ,$$

and γ∈[0, 1], |Φ^{⊥} [symbol] might be |ψ [symbol] -dependant. Moreover C can be implemented using a single application of the (controlled) U⁻²^{^{b}} gate and a single use of the (controlled) gates U²^{^{b−1}}, U²^{^{b−2}}, . . . , U¹ with using [symbol] (M) other two-qubit gates and a= [symbol] (log(M)) additional ancilla qubits.

This lemma is often used together with an oblivious amplitude amplification, which has the advantage over the usual amplitude amplification, that is does not need to uncompute the initial state during each iteration: (its proof can be found in the appendix)

### Lemma 4 (Generic Robust Oblivious Amplitude Amplification)

Let r∈ [symbol] ₊, ε∈[0, ½], Π₁, Π₂ orthogonal projectors and W a unitary such that for all |Φ [symbol] ∈Im(Π₁) it satisfies

$$‖ {\prod }_{2} W \vert ψ 〉 ‖ ∈ [ sin ( \frac{π / 2}{2 r + 1} ) ( 1 - ɛ ) , sin ( \frac{π / 2}{2 r + 1} ) ( 1 + ɛ ) ] . \qquad ( 1 )$$

Let G:=W(2Π₁−I)W^{†}(2Π₂−I), then for all |ψ [symbol] ∈Im(Π₁)

$$‖ {G}^{r} W \vert ψ 〉 = \frac{{\prod }_{2} W \vert ψ 〉}{sin ( \frac{π / 2}{2 r + 1} )} ‖ \leq \frac{7}{2} ɛ .$$

or in other words

$$‖ {G}^{r} W {\prod }_{1} = \frac{{\prod }_{2} W {\prod }_{1}}{sin ( \frac{π / 2}{2 r + 1} )} ‖ \leq \frac{7}{2} ɛ ,$$

Now the theorem is proved for multiplication, performed with phase arithmetics.

### Theorem 5

Suppose x,y∈[−1, 1], ε∈[0, ½] and one has access to phase oracles Oₓ, O_{y}, then one can implement an ε-approximate phase oracle Õ_{xy} using [symbol] (log(1/ε)) queries to Oₓ, O_{y} and their inverses, with using [symbol] (log²(1/ε)) additional gates and [symbol] (log log(1/ε)) additional ancilla qubits.

### Proof.

Using Stirling's approximation of the factorial, one can see that for some K= [symbol] (log(1/ε)/log log(1/ε)) one has that

$${\sum }_{k = K + 1}^{∞} \frac{1}{1 k !} \leq \frac{ɛ}{7} .$$

For such a K it is easy to see that

$$\vert {e}^{ixy} - {\sum }_{k = 0}^{K} \frac{{i}^{k}}{k !} {x}^{k} {y}^{k} \vert \leq ɛ / 7. \qquad ( 2 )$$

Moreover, for all x,y∈[−π/2, π/2] one has

$$\begin{matrix}{\sum }_{k = 0}^{K} \frac{{i}^{k}}{k !} {x}^{k} {y}^{k} = {\sum }_{k = 0}^{K} \frac{{i}^{k}}{k !} arc {sin}^{k} ( sin ( x ) ) arc {sin}^{k} ( sin ( y ) ) \\ = {\sum }_{k = 0}^{K} \frac{{i}^{k} {π}^{2 k}}{k ! {4}^{k}} \frac{arc {sin}^{k} ( sin ( x ) )}{{( π / 2 )}^{k}} \frac{arc {sin}^{k} ( sin ( y ) )}{{( π / 2 )}^{k}} .\end{matrix} \qquad ( 3 )$$

Now one can use the Taylor series representation arcsin^{k}(z)/(π/2)^{k}=Σₗ₌₀^{∞}bₗ^{(k)}z^{l} valid for all z∈[−1, 1]. As shown in Appendix B of Joran van Apeldoorn et al., “Quantum SDP-Solvers: Better upper and lower bounds,” arxiv 1705.01843v1 (2017), ∥b^{(k)}∥₁=1 and the coefficients are efficiently computable. Since x,y∈[−1, 1] one has that sin(x), sin(y)∈[− 6/7, 6/7]. On the other hand if z∈[− 6/7, 6/7] then for

$$L = ⌈ {log}_{\frac{7}{6}} ( 84 / ɛ ) ⌉$$

one gets that

$$\vert arc {sin}^{k} ( z ) / {( π / 2 )}^{k} - {\sum }_{𝓁 = 0}^{L} {b}_{𝓁}^{( k )} {z}^{𝓁} \vert \leq ɛ / 168. \qquad ( 4 )$$

Moreover, since

$${\sum }_{k = 0}^{K} \frac{{π}^{2 k}}{k ! {4}^{k}} < {e}^{{π}^{2} / 4} < 12 \qquad ( 5 )$$

by combining (3)-(4) one gets that

$$\vert {\sum }_{k = 0}^{K} \frac{{i}^{k}}{k !} {x}^{k} {y}^{k} - {\sum }_{k = 0}^{K} \frac{{i}^{k} {π}^{2 k}}{k ! {4}^{k}} {\sum }_{𝓁 = 0}^{L} {b}_{𝓁}^{( k )} {sin}^{𝓁} ( x ) {\sum }_{{𝓁}^{′} = 0}^{L} {b}_{{𝓁}^{′}}^{( k )} {sin}^{{𝓁}^{′}} ( y ) \vert \leq ɛ / 7. \qquad ( 6 )$$

Now one can use the fact that

$$sin ( x ) = \frac{{e}^{ix} - {e}^{- ix}}{2 i}$$

to conclude that after rearranging terms one can calculate a vector of coefficients c∈ [symbol] ^{(2L+1)}^{²} such that

$${\sum }_{k = 0}^{K} \frac{{i}^{k} {π}^{2 k}}{k ! {4}^{k}} {\sum }_{𝓁 = 0}^{L} {b}_{𝓁}^{( k )} {sin}^{𝓁} ( x ) {\sum }_{{𝓁}^{′} = 0}^{L} {b}_{{𝓁}^{′}}^{( k )} {sin}^{{𝓁}^{′}} ( y ) = {\sum }_{m = - L}^{L} {\sum }_{{m}^{′} = - L}^{L} {c}_{m , {m}^{′}} {e}^{imx ,} {e}^{{im}^{′} y} , \qquad$$

where ∥c∥₁≤≤12 as follows from (5). Using (2),(6) and the triangle inequality one can see that

$$\vert {e}^{ixy} - {\sum }_{m = - L}^{L} {\sum }_{{m}^{′} = - L}^{L} {c}_{m , {m}^{′}} {e}^{imx ,} {e}^{{im}^{′} y} \vert \leq 2 ɛ / 7. \qquad ( 7 )$$

Since 1/∥c∥₁≥ 1/12≥sin(π/38), using the LCU Lemma 3 one can implement a unitary W:

$${{\vert 1 〉 \vert 0 〉}^{⊗ a} \to \vert 1 〉 \vert 0 〉}^{⊗ a} {\sum }_{m = - L}^{L} {\sum }_{{m}^{′} = - L}^{L} sin ( π / 38 ) {c}_{m , {m}^{′}} {e}^{imx} {e}^{{im}^{′} y} + γ \vert {Φ}^{⊥} 〉$$

s.t. (I⊗|0 [symbol] [symbol] 0|^{⊗a})|Φ^{⊥} [symbol] =0, with 2L uses of Oₓ, O_{y}, or their inverses, [symbol] (L²) extra gates (If y is a known number as discussed in Subsection III.B.2. “Multiplying a phase with a fixed real number,” then one of the summations can be precomputed in order to reduce the state preparation step to have gate complexity only [symbol] (L)) and a= [symbol] (log(L)) additional qubits. Since π/2=(2·9+1)π/38, as Lemma 4 shows, using 9 oblivious amplitude amplification steps on W one gets an ε-approximate oracle Õ_{xy}. This final step only adds a constant factor to the gate complexity and qubit count. □

III.B.2. Multiplying a Phase with a Fixed Real Number

This subsection discusses how to calculate multiplication by a fixed number λ∈ [symbol] . Note that this case is not immediately covered by the previous results because λ can be greater than 1 in magnitude.

### Lemma 6

Suppose λ∈ [symbol] , x∈[−1, 1] and one has access to the phase oracles Oₓ, then one can implement an ε-approximate phase oracle Õ_{λx} using [symbol] (|λ|+log(1/ε)) queries to Oₓ and its inverse, with using [symbol] (log(1/ε)) additional gates and [symbol] (log log(1/ε)) additional ancilla qubits.

### Proof.

First, Oₓ is repeated a total number of └λ┘ times, then the query O_{λx} is implemented using the techniques of Theorem 5 replacing in (7) the e^{im′y} terms with the number e^{im′(λ-└λ┘)}. Since it reduces the number of LCU terms, as noted in the proof, the additional gate complexity coming from state preparation reduces to [symbol] (log(1/ε)). □

Note that in the above proof one can think about e^{ix(λ-└λ┘)} as a fractional phase query. This fractional query is a generalization of the fractional query introduced for discrete phases by Cleve et al., “Efficient discrete-time simulations of continuous-time quantum query algorithms,” Proceedings of the 41st Annual ACM Symposium on Theory of Computing, pgs. 409-416 (2009), arxiv 0811.4428. The fractional query method described in that reference cannot be directly applied to the continuous phase oracle that is described herein. There is also an alternative approach Sheridan et al., “Approximating fractional time quantum evolution”, Journal of Physics A, volume 42(18), pgs. 185302 (2009), for fractional queries for generic unitaries, however its complexity depends polynomially on the precision rather than logarithmically as the described method does for diagonal unitaries.

The above method is easy to generalize to the case when one has vectors, e.g., one can implement O_{\vec{z}} with similar complexity where zⱼ=xⱼ·yⱼ.

Finally, a lemma is used which will be used for implementing Fourier series.

### Lemma 7

Suppose one uses b+1 qubits to represent the integers of [−2^{b}, 2^{b}−1] using signed (qu)bitstrings, such that (m_{b}m_{b-1} . . . m₁, m₀) encodes the number m=−m_{b}2^{b}+Σᵥ₌₀^{b-1}mᵥ2^{v}. If [symbol] [symbol] γ= [symbol] (1), then one can implement a unitary Ũ, which is ε close to a unitary

$$U = \vert 0 〉 {〈 0 \vert}^{⊗ a} ⊗ {\sum }_{m ∈ S} \vert m 〉 〈 m \vert {e}^{im γ x} + V , \\ where \\ ( \vert 0 〉 {〈 0 \vert}^{⊗ a} ⊗ {I}_{2}^{⊗ ( b + 1 )} ) V = 0$$

using [symbol] (2^{b}+b log(b/ε)) queries to Oₓ, with the use of [symbol] (b log(b/ε)) additional two-qubit gates and a= [symbol] (log log(b/ε)) additional ancilla qubits.

### Proof.

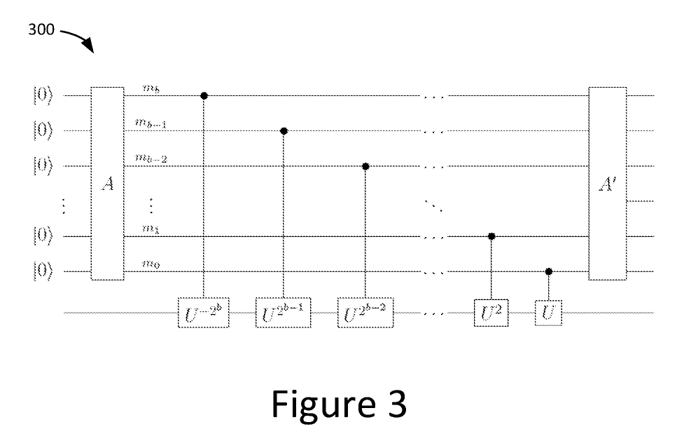

Here, a signed binary representation, similarly to circuit 300 shown in FIG. 3 is used. In particular Σₘ₌₋₂_{^{b}}²^{^{b}}⁻¹|m [symbol] [symbol] m|e^{imγx} can be written as

$$( ( \vert 0 〉 〈 0 \vert + \vert 1 〉 〈 1 \vert {e}^{- i {2}^{b} γ x} ) ⊗ {I}_{2}^{b} ) {\prod }_{v = 0}^{b} {I}_{2}^{⊗ b - v} ⊗ ( \vert 0 〉 〈 0 \vert + \vert 1 〉 〈 1 \vert {e}^{i {2}^{v} γ x} ) ⊗ {I}_{2}^{v - 1} . \qquad ( 8 )$$

Using Lemma 6 one can implement the phase oracle | [symbol] [symbol] 0|+|1 [symbol] [symbol] 1|e^{±i2}^{^{v}}^{γx} with ε/(b+1) precision using [symbol] (2^{v}+log(b/ε)) queries to Oₓ with using [symbol] (log(b/ε)) additional two-qubit gates and [symbol] (log log(b/ε)) additional ancilla qubits. Using the decomposition of the circuit 300 in FIG. 3, this yields an ε precise implementation of the operator U using [symbol] (2^{b}+b log(b/ε)) queries to Oₓ with the use of [symbol] (b log(b/ε)) additional two-qubit gates and [symbol] (log log(b/ε)) additional ancilla qubits, since the ancilla qubits can be reused. □

III.B.3. Multiplying Multiple Phases

If one looks at the multiplication that has been devised for two phases it seems like the cost blows up exponentially for multiplying multiple phases together. This subsection explains how to keep the cost polynomial in the number of terms.

### Theorem 8

Suppose ε∈(0, ½), \vec{x}∈[−1, 1]^{N} for integer N≥1 and one has access to the phase oracle O_{\vec{x}}, then one can implement an ε-approximate phase oracle

$${\tilde{O}}_{{Π}_{j = 1}^{N} {x}_{j}}$$

for ϵ≤1 using [symbol] (N² log(N/ε) log log(1/ε)) queries to O_{\vec{x}} and its inverse, with using [symbol] (N² log²(N/ε)) additional gates and a total number of [symbol] (N(log(N)+log log(1/ε))) ancilla qubits.

### Proof.

Similarly as in the proof of Theorem 5, for some K= [symbol] (log(1/ε)/log log(1/ε))

$$\vert {e}^{i {\prod }_{j = 1}^{N} {x}_{j}} - {\sum }_{k = 0}^{K} \frac{{i}^{k}}{k !} {\prod }_{j = 1}^{N} {x}_{j}^{k} \vert \leq ɛ / 14. \\ Moreover \\ {\sum }_{k = 0}^{K} \frac{{i}^{k}}{k !} {\prod }_{j = 1}^{N} {x}_{j}^{k} = {\sum }_{k = 0}^{K} \frac{{i}^{k}}{k !} {( \frac{2}{π ( 1 - 1 / ( 2 N ) )} )}^{Nk} {\prod }_{j = 1}^{N} {( {x}_{j} \frac{π ( 1 - 1 / ( 2 N ) )}{2} )}^{k} = {\sum }_{k = 0}^{K} \frac{{i}^{k}}{k !} {( \frac{1}{1 - 1 / ( 2 N )} )}^{Nk} {\prod }_{j = 1}^{N} \frac{{arcsin}^{k}}{{( 2 / π )}^{k}} ( sin ( {x}_{j} \frac{π ( 1 - 1 / ( 2 N ) )}{2} ) ) = {\sum }_{k = 0}^{K} \frac{{i}^{k}}{k !} {γ}_{N}^{k} {\prod }_{j = 1}^{N} {\sum }_{𝓁 = 1}^{∞} {b}_{𝓁}^{( k )} {sin}^{𝓁} ( {x}_{j} \frac{π ( 1 - 1 / ( 2 N ) )}{2} ) , \\ where γ N = {( \frac{1}{1 - 1 / ( 2 N )} )}^{N} \leq \frac{16}{9} . \qquad ( 9 )$$

Now one can use that ∥b^{(k)}∥₁=1,

$${\sum }_{k = 0}^{K} \frac{1}{k !} {γ}_{N}^{k} < {e}^{16 / 9} < 6 , \\ and \\ sin ( {x}_{j} \frac{π ( 1 - 1 / ( 2 N ) )}{2} ) \leq 1 - Θ ( 1 / {N}^{2} ) \qquad ( 10 )$$

so one has that for some L= [symbol] (N² log(N/ε))

$$\vert {\sum }_{k = 0}^{K} \frac{{i}^{k}}{k !} {\prod }_{j = 1}^{N} {x}_{j}^{k} - {\sum }_{k = 0}^{K} \frac{{i}^{k} {γ}_{N}^{k}}{k !} {\prod }_{j = 1}^{N} {\sum }_{𝓁 = 1}^{L} {b}_{𝓁}^{( k )} {sin}^{𝓁} ( {x}_{j} \frac{π ( 1 - 1 / ( 2 N ) )}{2} ) \vert \leq ɛ / 28. \qquad ( 11 )$$

Let ε′:=ε/196, now one can use the fact that

$$sin ( z ) = \frac{{e}^{iz} - {e}^{- iz}}{2 i}$$

in combination with the Chernoff bound to conclude that (see e.g. Appendix B.1 Eq. (16) of Joran van Apeldoorn et al., “Quantum SDP-Solvers: Better upper and lower bounds,” arxiv 1705.01843v1 (2017)) for some M′= [symbol] (N log(N/ε)) and for all l≤≥L

$$\vert \underbrace{\overbrace{{( \frac{i}{2} )}^{𝓁} {\sum }_{{m}^{′} = ⌈ 𝓁 / 2 ⌉ - {M}^{′}}^{⌊ 𝓁 / 2 ⌋ + {M}^{′}} {( - 1 )}^{{m}^{′}} ( \begin{matrix}𝓁 \\ {m}^{′}\end{matrix} ) {e}^{i ( 2 {m}^{′} - 𝓁 ) z}}^{g ( z , 𝓁 ) \text{:} \text{=}} - {sin}^{𝓁} ( z )}_{c ( z , 𝓁 ) \text{:} \text{=}} \vert \leq \frac{{ɛ}^{′}}{N} . \\ Let {z}_{j} \text{:} \text{=} {x}_{j} \frac{π ( 1 - 1 / ( 2 N ) )}{2} , then$$

$$\vert {\sum }_{k = 0}^{K} \frac{{i}^{k} {γ}_{N}^{k}}{k !} ( {\prod }_{j = 1}^{N} {\sum }_{𝓁 = 1}^{L} {b}_{𝓁}^{( k )} g ( {z}_{j} , 𝓁 ) - {\prod }_{j = 1}^{N} {\sum }_{𝓁 = 1}^{L} {b}_{𝓁}^{( k )} {sin}^{𝓁} ( {z}_{j} ) ) \vert \leq 6 { max}_{k} \vert {\prod }_{j = 1}^{N} {\sum }_{𝓁 = 1}^{L} {b}_{𝓁}^{( k )} g ( {z}_{j} , 𝓁 ) - {\prod }_{j = 1}^{N} {\sum }_{𝓁 = 1}^{L} {b}_{𝓁}^{( k )} {sin}^{𝓁} ( {z}_{j} ) \vert = 6 {max}_{k} \vert {\prod }_{j = 1}^{N} {\sum }_{𝓁 = 1}^{L} {b}_{𝓁}^{( k )} ( {sin}^{𝓁} ( {z}_{j} ) + c ( {z}_{j} , 𝓁 ) ) - {\prod }_{j = 1}^{N} {\sum }_{𝓁 = 1}^{L} {b}_{𝓁}^{( k )} {sin}^{𝓁} ( {z}_{j} ) \vert$$

Now one can use the identity:

$${\prod }_{j = 1}^{N} ( {a}_{j} + {c}_{j} ) - {\prod }_{j = 1}^{N} {a}_{j} = {\sum }_{{j}^{′} = 1}^{N} ( {\prod }_{j = 1}^{{j}^{′} - 1} {a}_{j} ) {c}_{{j}^{′}} ( {\prod }_{j = {j}^{′} + 1}^{N} ( {a}_{j} + {c}_{j} ) ) = 6 { max}_{k} \vert {\sum }_{{j}^{′} = 1}^{N} ( {\prod }_{j = 1}^{{j}^{′} - 1} {\sum }_{𝓁 = 1}^{L} {b}_{𝓁}^{( k )} {sin}^{𝓁} ( {z}_{j} ) ) ( {\sum }_{𝓁 = 1}^{L} {b}_{𝓁}^{( k )} c ( {z}_{{j}^{′}} , 𝓁 ) ) ( {\prod }_{j = {j}^{′} + 1}^{N} {\sum }_{𝓁 = 1}^{L} {b}_{𝓁}^{( k )} ( {sin}^{𝓁} ( {z}_{j} ) + c ( {z}_{j} , 𝓁 ) ) ) \vert \leq 6 {max}_{k} \vert {\sum }_{{j}^{′} = 1}^{N} {1}^{{j}^{′} - 1} \frac{{ɛ}^{′}}{N} {( 1 + \frac{{ɛ}^{′}}{N} )}^{N - j} \vert \leq 6 \vert {{ɛ}^{′} ( 1 + {ɛ}^{′} / N )}^{N} \vert \leq 6 {ɛ}^{′} {e}^{{ϵ}^{′}} \leq 6 {ɛ}^{′} {e}^{1 / 8} \leq 7 {ɛ}^{′} = ɛ / 28. \qquad ( 12 )$$

One can therefore conclude from the triangle inequality and equations (11) and (12) that

$$\vert {\sum }_{k = 0}^{K} \frac{{i}^{k}}{k !} {\prod }_{j = 1}^{N} {x}_{j}^{k} - {\sum }_{k = 0}^{K} \frac{{i}^{k} {γ}_{N}^{k}}{k !} {\prod }_{j = 1}^{N} {\sum }_{𝓁 = 1}^{L} {{b}_{𝓁}^{( k )} ( \frac{i}{2} )}^{𝓁} {\sum }_{{m}^{′} = ⌈ 𝓁 / 2 ⌉ - {M}^{′}}^{⌊ 𝓁 / 2 ⌋ + {M}^{′}} {( - 1 )}^{{m}^{′}} ( \begin{matrix}𝓁 \\ {m}^{′}\end{matrix} ) {e}^{i ( 2 {m}^{′} - 𝓁 ) {x}_{j} \frac{π ( 1 - 1 / ( 2 N ) )}{2}} \vert \leq \frac{ɛ}{14} . \qquad$$

Let M=2M′, after rearranging the terms and substituting m:=2m′−l one gets that

$${\sum }_{k = 0}^{K} \frac{{i}^{k} {γ}_{N}^{k}}{k !} {\prod }_{j = 1}^{N} {\sum }_{𝓁 = 1}^{L} {{b}_{𝓁}^{( k )} ( \frac{i}{2} )}^{𝓁} {\sum }_{{m}^{′} = ⌈ 𝓁 / 2 ⌉ - {M}^{′}}^{⌊ 𝓁 / 2 ⌋ + {M}^{′}} {( - 1 )}^{{m}^{′}} ( \begin{matrix}𝓁 \\ {m}^{′}\end{matrix} ) {e}^{i ( 2 {m}^{′} - 𝓁 ) {x}_{j} \frac{π ( 1 - 1 / ( 2 N ) )}{2}} = {\sum }_{k = 0}^{K} \underbrace{\frac{{i}^{k} {γ}_{N}^{k}}{k !}}_{{c}_{k}^{′}} {\prod }_{j = 1}^{N} {\sum }_{m = - M}^{M} {\sum }_{{𝓁 ∈ \{ 0 , 1 , … , L \}}_{m + 𝓁 even}} {{b}_{𝓁}^{( k )} ( \frac{i}{2} )}^{𝓁} {( - 1 )}^{( m + 𝓁 ) / 2} ( \begin{matrix}𝓁 \\ ( m + 𝓁 ) / 2\end{matrix} ) {e}^{{imx}_{j} \frac{π ( 1 - 1 / ( 2 N ) )}{2}} = {\sum }_{k = 0}^{K} \underbrace{\frac{{i}^{k} {γ}_{N}^{k}}{k !}}_{{c}_{k}^{′}} {\prod }_{j = 1}^{N} {\sum }_{m = - M}^{M} \underbrace{{( - i )}^{m} {\sum }_{{𝓁 ∈ \{ 0 , 1 , … , L \}}_{m + 𝓁 even}} {b}_{𝓁}^{( k )} {2}^{- 𝓁} ( \begin{matrix}𝓁 \\ ( m + 𝓁 ) / 2\end{matrix} )}_{{c}_{k , m}^{″}} {e}^{{imx}_{j} \frac{π ( 1 - 1 / ( 2 N ) )}{2}} = {\sum }_{k = 0}^{K} {c}_{k}^{′} {\prod }_{j = 1}^{N} {\sum }_{m = - M}^{M} {c}_{k , m}^{″} {e}^{{imx}_{j} \frac{π ( 1 - 1 / ( 2 N ) )}{2}} .$$

Let cₖ:=cₖ′·(cₖ″)^{⊗N}, and note that ∥c∥₁≤6 because ∥cₖ″∥₁≤1 and ∥c′∥₁≤6 from (10). Combing the above inequality with (9) using the triangle inequality, one can see that

$$\vert {e}^{i {\prod }_{j = 1}^{N} {x}_{j}} - {\sum }_{k = 0}^{K} {c}_{k}^{′} {\prod }_{j = 1}^{N} {\sum }_{m = - M}^{M} {c}_{k , m ,}^{″} {e}^{{imx}_{j} \frac{π ( 1 - 1 / ( 2 N ) )}{2}} \vert \leq ɛ / 7. \qquad ( 13 )$$

We then use the General LCU Lemma 14 to implement a unitary U:

$$\vert 1 〉 {\vert 0 〉}^{⊗ α} \to \vert 1 〉 {\vert 0 〉}^{⊗ α} sin ( π / 22 ) {\sum }_{k = 0}^{K} {c}_{k}^{′} {\prod }_{j = 1}^{N} {\sum }_{m = - M}^{M} {c}_{k , m ,}^{″} {e}^{{imx}_{j} \frac{π ( 1 - 1 / ( 2 N ) )}{2}} + γ \vert {Φ}^{⊥} 〉 ,$$

such that (I⊗|0 [symbol] [symbol] 0|^{⊗a})|Φ^{⊥} [symbol] =0.

Let b:=┌log₂(M+2)┐, S:={−2^{b}, −2^{b}+1, −2^{b}+2, . . . , 2^{b}−1} and let

$$\begin{matrix}U := {\sum }_{\vec{m} ∈ {S}^{N}} {⊗}_{j ∈ [ N ]} \vert {m}_{j} 〉 〈 {m}_{j} \vert {e}^{{im}_{j} {x}_{j} \frac{π ( 1 - 1 / ( 2 N ) )}{2}} \\ = {\prod }_{j ∈ [ N ]} {I}_{S}^{⊗ j - 1} ⊗ ( {\sum }_{m ∈ S} \vert m 〉 〈 m \vert {e}^{im {x}_{j} \frac{π ( 1 - 1 / ( 2 N ) )}{2}} ) ⊗ {I}_{S}^{⊗ N - j} .\end{matrix} \qquad ( 14 )$$

As shown by Lemma 7 one can implement the operator

$$( {\sum }_{m ∈ S} \vert m 〉 〈 m \vert {e}^{im {x}_{j} \frac{π ( 1 - 1 / ( 2 N ) )}{2}} )$$

with ε/(22N) precision using [symbol] (M+b log(Nb/ε))= [symbol] (M log log(1/ε)) queries to Oₓ_{ⱼ} with the use of [symbol] (b log(Nb/ε))= [symbol] (M log log(1/ε)) additional two-qubit gates and and [symbol] (log log(Nb/ε)) additional ancilla qubits. Using (14) one can implement Ũ, an ε/22 precise implementation of U, using [symbol] (N M log log(1/ε)) queries to O_{\vec{x}} with the use of [symbol] (NM log log(1/ε)) additional two-qubit gates and still only [symbol] (log log(Nb/ε)) additional ancilla qubits, because the ancilla qubits can be reused.

Now it is shown how to implement the unitaries A and B needed for applying the General LCU Lemma 14. Let a=┌log₂(K+3)┐ and let |\sqrt{|c′|} [symbol] :=Σₖ₌₀^{K}\sqrt{|cₖ′|}|k [symbol] . Since 1/∥c∥₁≥⅙≥sin(π/22), using the techniques of Vivek V. Shende, et. al., “Synthesis of quantum-logic circuits,” IEEE Trans. on CAD of Integrated Circuits and Systems, vol. 25, no. 6, pgs. 1000-1010 (2006), one can implement the unitary

A′:|0 [symbol] →\sqrt{sin(π/22)}|\sqrt{|c′|} [symbol] +\sqrt{1−sin(π/22)∥c′∥₁}|K+1 [symbol] ,

and similarly

B′:|0 [symbol] →\sqrt{sin(π/22)}|\sqrt{|c′|} [symbol] +\sqrt{1−sin(π/22)∥c′∥₁}|K+1 [symbol] ,

using [symbol] (K) two-qubit gates and with only using a= [symbol] (log(K)) qubits.

Similarly let b=┌log₂(2M+3)┐ and let |\sqrt{|cₖ″|} [symbol] :=Σ_{m=-M}^{M}\sqrt{|c_{k,m}″|}|m [symbol] . Using the techniques of Vivek V. Shende, et. al., “Synthesis of quantum-logic circuits,” IEEE Trans. on CAD of Integrated Circuits and Systems, vol. 25, no. 6, pgs. 1000-1010 (2006) one can implement the unitary

Aₖ″:|0 [symbol] →|\sqrt{|cₖ″|} [symbol] +\sqrt{1−∥cₖ″∥₁}|−M−1 [symbol] ,

and similarly

Bₖ″:|0 [symbol] →|\sqrt{|cₖ″|} [symbol] +\sqrt{1−∥cₖ″∥₁}|−M−1 [symbol] ,

using [symbol] (M) two-qubit gates and with only using b= [symbol] (log(M)) qubits.

Finally let P′=(Σₖ₌₀²^{^{a}}⁻¹i^{k}|k [symbol] [symbol] k|) and P″=(Σₘ₌₋₂_{^{b}}²^{^{b}}⁻¹(−i)^{m}|m [symbol] [symbol] m|) both of which can be implemented using an application of a single qubit phase gate. (Here, the integers are represented as signed binary values.)

Therefore one can implement the unitaries

$$A := ( {\sum }_{k = 0}^{K} \vert k 〉 〈 k \vert ⊗ {( {P}^{″} {A}_{k}^{″} )}^{⊗ N} ) \cdot {P}^{′} {A}^{′} , \\ B := ( {\sum }_{k = 0}^{K} \vert k 〉 〈 k \vert ⊗ {( {B}_{k}^{″} )}^{⊗ N} ) \cdot {A}^{′} ,$$

using [symbol] (K+KNM)= [symbol] (N² log²(N/ε)) gates while the number of used qubits is only [symbol] (a+Nb)= [symbol] (N(log(N)+log log(1/ε))) qubits.

Let \tilde{W}=B^{†}(I⊗Ũ)A and W=B^{†}(I⊗U)A then because A and B are unitary

∥W−\tilde{W}∥=∥U−Ũ∥≤ϵ/22.

Since π/2=(2·5+1)π/22, one can implement an ε/2 precise phase oracle using 5 oblivious amplitude amplification steps on W, as (13) and Lemma 4 shows. Since 2·5+1=11, 11 applications of W are used in the protocol. One gets at most ε/2 error form the oblivious amplitude amplification. Moreover the total error obtained from the imperfect LCU implementation of \tilde{W} is 11·ϵ/22=ϵ/2. If one combines this error with that from (13), one can note that the process leads to at most an ϵ/4+3/ϵ/4=ϵ-approximate query to

$${\tilde{O}}_{{Π}_{j = 1}^{N} {x}_{j}} .$$

The final procedure uses [symbol] (M N log log(1/ε))= [symbol] (N² log(N/ε) log log(1/ε)) queries to O_{\vec{x}} and its inverse, with the use of [symbol] (N² log²(N/ε)) additional two-qubit gates and [symbol] (N(log(N)+log log(1/ε))) ancilla qubits. □

III.C. Function Application

Since it has already been described how to perform addition and multiplication, one can approximately implement functions in the phase, e.g., using a truncated Taylor series. However, in many cases it can be more efficient to implement functions directly using LCU techniques. In this subsection, example general techniques showing how to implement general functions in phase are described. It will be convenient to work with probability (or amplitude) oracles and then convert them back to phase. All the techniques that are described can be generalized to vector access, but for the sake of simplicity the discussion works with the scalar case.

III.C.1 Phase Oracles for Expectation Values

The first result that is demonstrated is a method for computing the real and imaginary components of [symbol] ψ|W|ψ [symbol] as a phase oracle given access to a unitary process for preparing the state |ψ [symbol] . The idea behind this approach is to use the Hadamard test to compute the result as a probability oracle and then converting this to a phase oracle using known techniques. This will be necessary for the function evaluation methods that are provided below.

The first concept that is described is that of a probability oracle. This concept, formalized in András Gilyen et al., “Optimizing quantum optimization algorithms via faster quantum gradient computation,” arxiv:1711.00465 (2017), is an oracle that outputs the desired answer as a probability. These oracles, which are implicitly used in many quantum machine learning algorithms, are explicitly defined below.

### Definition 9 (Probability Oracle)

One can say Uₚ is a probability oracle for a real number p∈[0, 1]^{N}

Uₚ:|1 [symbol] |\vec{0} [symbol] |0 [symbol] →|1 [symbol] ⊗(\sqrt{pₖ}|ψ_{good} [symbol] |1 [symbol] +\sqrt{1−pₖ}|ψ_{bad} [symbol] |0 [symbol] ),

where |ψ_{good} [symbol] and |ψ_{bad} [symbol] are arbitrary quantum states and Uₚ(|0 [symbol] [symbol] 0|⊗I)=|0 [symbol] [symbol] 0|⊗I.

In order to convert a probability oracle to a phase oracle, the following observation can be made. Let

|ψ [symbol] :=\sqrt{p}|ψ_{good} [symbol] |1 [symbol] +\sqrt{1−pₖ}|ψ_{bad} [symbol] |0 [symbol] =Uₚ|1 [symbol] |0 [symbol] ^{⊗n}.

One can define a version of the Grover operator G_{U} as follows

G_{U}=|0 [symbol] [symbol] 0|⊗I+|1 [symbol] [symbol] 1|⊗((2|0 [symbol] [symbol] 0|^{⊗n}−Iₙ)Uₚ^{†}(2Iₙ₋₁⊗|0 [symbol] [symbol] 0|−Iₙ)Uₚ).

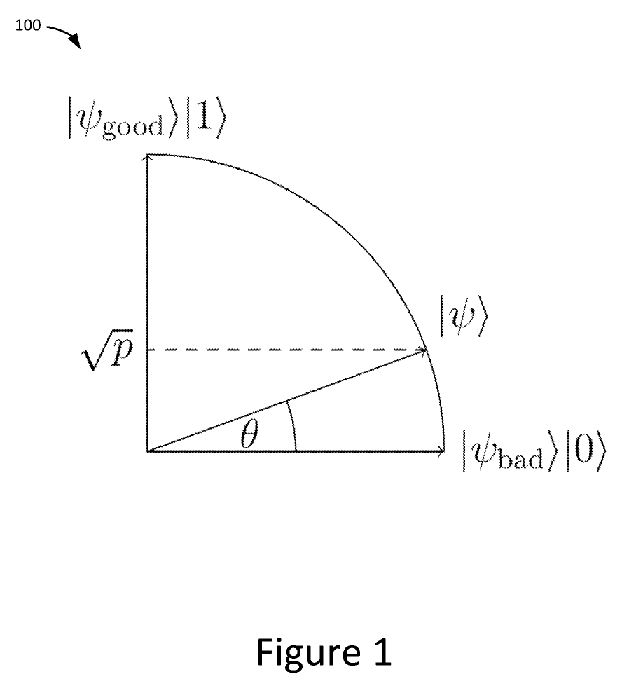

It is well known that the state |1 [symbol] |0 [symbol] ^{⊗n} lies in a two dimensional invariant subspace, on which G_{U} acts as a rotation operator with rotation angle 2θ (see FIG. 1, which is a diagram 100 showing a geometric illustration of the parameters of the Grover operator G_{U}), where

θ=arcsin(∥(Iₙ₋₁⊗|1 [symbol] [symbol] 1 [symbol] [symbol] 1|)Uₚ|1 [symbol] |0 [symbol] ^{⊗n}∥)=arcsin(\sqrt{p}).

Therefore, |0 [symbol] ^{⊗n} is a superposition of two eigenstates of G_{U}, with eigenvalues e^{-±2iθ}.

This intuition that Grover's oracle can be used as a means to convert probability to phase is also the central intuition behind amplitude estimation (see, e.g., Brassard et al., “Quantum amplitude amplification and estimation,” Contemporary Mathematics, vol. 305, pgs. 53-73 (2002), which uses this fact only in the context of phase estimation. Below, a generalized form of this observation is formally stated. The generalized form additionally removes the need to compute arcsin by incorporating the function in the LCU circuit. The next results is formally proven in Andrs Gilyen et al., “Optimizing quantum optimization algorithms via faster quantum gradient computation,” arxiv:1711.00465 (2017) but the result and proof are restated here for completeness.

### Theorem 10

Let U be a unitary satisfying U|0^{⊗n}=\sqrt{p}|ψ_{good} [symbol] 1 [symbol] +\sqrt{1−p}|ψ_{bad} [symbol] |0 [symbol] , and suppose one has access to controlled-versions of U and U^{†}. Then, for ε∈(0, ⅓), a controlled-unitary Õₚ can be implemented such that

∥Õₚ|0 [symbol] ^{⊗(n+a)}−e^{ip}|0 [symbol] ^{⊗(n+a)}∥≤ε,

using [symbol] (log(1/ε)) applications of controlled U and U^{†}.

### Proof.

An example implementation will be based on using the Grover operator G_{U} discussed before FIG. 1. Since the primary interest is the image of the |0 [symbol] ^{⊗n} state, the focus below is on the two dimensional invariant subspace of G_{U} induced by |0 [symbol] ^{⊗n}. G denotes the operator induced by G_{U} on this subspace:

$$G = ( \begin{matrix}{e}^{2 i θ} & 0 \\ 0 & {e}^{- 2 i θ}\end{matrix} ) = {e}^{2 iH} where H = ( \begin{matrix}θ & 0 \\ 0 & - θ\end{matrix} ) .$$

By recalling that p=sin² (θ) therefore using the Taylor expansion of e^{iθ}, one has

$${e}^{ip} \cdot I = {e}^{i {sin}^{2} ( θ )} \cdot I = {e}^{i {sin}^{2} ( H )} = {\sum }_{k = 0}^{∞} \frac{{i}^{k}}{k !} {sin}^{2 k} ( H ) .$$

Using triangle inequality and a geometric bound one has: for all M∈ [symbol] _{†},

$$‖ {e}^{ip} \cdot I - {\sum }_{k = 0}^{M} \frac{{i}^{k}}{k !} {sin}^{2 k} ( H ) ‖ \leq {\sum }_{k = M + 1}^{∞} \frac{1}{k !} \leq \frac{1}{M !} . \qquad ( 15 )$$

Now, let ε′∈(0, ⅓) and M:=2 ln(1/ε′)/ln ln(1/ε′) so that 1/M!≤(e/M)^{M}≤ε′. Finally one can define β∈ [symbol] ^{2M+1} using the following calculation:

$$\begin{matrix}{\sum }_{k = 0}^{M} \frac{{i}^{k}}{k !} {sin}^{2 k} ( H ) = {\sum }_{k = 0}^{M} \frac{{i}^{k}}{k !} {( \frac{{e}^{iH} - {e}^{- iH}}{2 i} )}^{2 k} \\ ( since sin ( θ ) = ( {e}^{i θ} - {e}^{- i θ} ) / ( 2 i ) ) \\ = {\sum }_{k = 0}^{M} \frac{{( - i )}^{k}}{k !} {\sum }_{𝓁 = 0}^{2 k} ( \begin{matrix}2 k \\ 𝓁\end{matrix} ) \frac{{( - 1 )}^{𝓁}}{{2}^{2 k}} {e}^{2 i ( k - 𝓁 ) H} \\ = {\sum }_{k = 0}^{M} \frac{{( - i )}^{k}}{k !} {\sum }_{m = - k}^{k} ( \begin{matrix}2 k \\ k - m\end{matrix} ) \frac{{( - 1 )}^{k - m}}{{2}^{2 k}} {e}^{2 imH} \\ ( let 𝓁 ← ( k - m ) ) \\ = {\sum }_{m = - M}^{M} {e}^{2 imH} {\sum }_{k = \vert m \vert}^{M} ( \begin{matrix}2 k \\ k - m\end{matrix} ) \frac{{( - 1 )}^{m} {i}^{k}}{k ! {2}^{2 k}} \\ = {\sum }_{m = - M}^{M} {G}^{m} {\sum }_{k = \vert m \vert}^{M} ( \begin{matrix}2 k \\ k - m\end{matrix} ) \frac{{( - 1 )}^{m} {i}^{k}}{k ! {2}^{2 k}} \\ ( \text{since} G = {e}^{2 iH} \text{by} \text{definition} ) \\ \text{=:} {\sum }_{m = - M}^{M} {G}^{m} {β}_{m} . \\ ( this is the defining equation of {β}_{m} )\end{matrix} \qquad ( 16 )$$

By the calculation above and Eq. (15), one has

$$‖ {e}^{ip} \cdot I - {\sum }_{m = - M}^{M} {β}_{m} {G}^{m} ‖ \leq {ɛ}^{′} and {‖ β ‖}_{1} \leq e , \qquad ( 17 )$$

the latter devised from

$${\sum }_{k = 0}^{M} \frac{1}{k !} \leq e$$

and an application of the triangle inequality in (16).

This representation makes it possible to use the LCU Lemma 3. By setting a:=┌log₂(2M+1)┐+1 (the number of auxiliary qubits), one can implement the unitary

$${{V {\vert 0 〉}^{⊗ n} \vert 0 〉}^{⊗ a} = sin ( π / 2 ) {\sum }_{m = - M}^{M} {β}_{m} {G}_{U}^{m} {\vert 0 〉}^{⊗ n} \vert 0 〉}^{⊗ a} + γ \vert {Φ}^{⊥} 〉 ,$$

where (I⊗|0 [symbol] [symbol] 0|^{⊗a})|Φ^{⊥} [symbol] =0, using [symbol] (M) invocations of the controlled G_{U} and G_{U}^{†} gates and [symbol] (M log(M)) other two-qubit gates (we used the fact that ∥β∥₁≤e≤1/sin(π/10)). Using Eq. (17) it can be seen that

∥(I⊗|1 [symbol] [symbol] 1|^{⊗a})V|0 [symbol] ^{⊗a}|0 [symbol] ^{⊗a}−sin(π/10)e^{ip}|0 [symbol] ^{⊗n}∥≤sin(π/10)ε′.

Let Õₚ denote the circuit that uses two amplitude amplification steps on the state |0 [symbol] ^{⊗a} using the circuit V′. It is not hard to see that

∥Õₚ|0 [symbol] ^{⊗n}|0 [symbol] ^{⊗a}−e^{ip}|0 [symbol] ^{⊗n}|0 [symbol] ^{⊗a}∥= [symbol] (ε′).

Therefore choosing an appropriate constant to determine the value ε′:=Θ(ε) proves the claim, since Õₚ is implemented with the desired complexity. □

Theorem 10 gives the cost of converting a probability oracle to a phase oracle. This result is used below to show how to use these resources to compute the expectation value of an operator as a phase oracle.

### Corollary 11

Suppose one has access to a unitary V:|0 [symbol] ^{⊗n}→|ϕ [symbol] and a controlled unitary W. Then one can implement an ε-approximate phase oracle Õ_{Re((ϕ|W|ϕ))} with [symbol] (log(1/ε)) uses of V, W and their inverses.

### Proof.

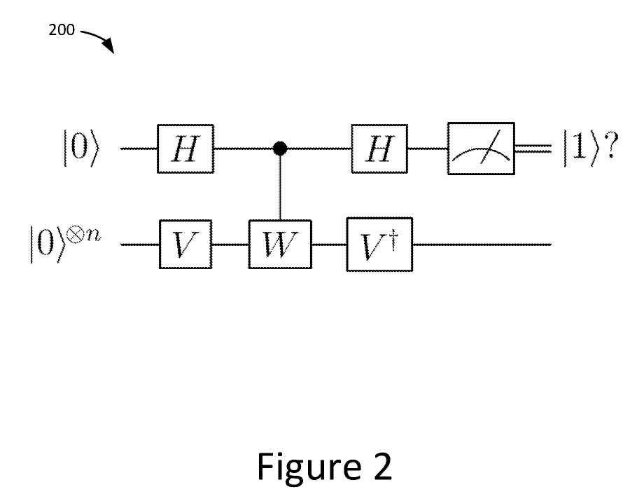

The proof idea is based on the Hadamard test. In this regard, FIG. 2 is a block diagram 200 showing a Hadamard test circuit where the probability of measuring |1 [symbol] is

$$\frac{1 + Re ( 〈 φ \vert U \vert φ 〉 )}{2} .$$

(Note that V^{†} is only there to ensure that if W=I the circuit does not change the quantum state, which is helpful if one wants to make the above circuit controlled.)

The probability of measuring |1 [symbol] is

$$\frac{1 + Re ( 〈 φ \vert U \vert φ 〉 )}{2} .$$

(Note that V^{†} is only there to ensure that if W=I the circuit does not change the quantum state, which is helpful if one wants to make the above circuit controlled.) The above is treated as a probability oracle for

$$p = \frac{1 + Re ( 〈 φ \vert W \vert φ 〉 )}{2} ,$$

and use Theorem 10. One can multiply its phase by 2 and subtract 1 to get the final phase oracle Õ_{(ϕ|W|ϕ)}=Õ₂ₚ₋₁. □

Now that one has this result, which shows how to compute the expectation value of a unitary operator as a phase, one can apply it to constructing a phase oracle for sin(ϕ) and cos(ϕ) where ϕ∈[−1, 1].

### Corollary 12

One can implement Õₛᵢₙ₍ₓ₎ or Õ_{cos(x)} with [symbol] (log(1/ε)) uses of Oₓ.

### Proof.

Use Corollary 11 choosing V=I and W=Oₓ for cos(x) and W=−iOₓ, for sin(x). □

One can generalize the above corollary for using the LCU techniques of Theorem 40, Corollary 42 of Joran van Apeldoorn et al., “Quantum SDP-Solvers: Better upper and lower bounds,” arxiv 1705.01843v1 (2017), which is presented in the next lemma:

### Lemma 13

Suppose c∈ [symbol] ₊^{2M+1}, γ=Θ(1) are given such that ƒ(x)=Σ_{m=-M}^{M}cₘe^{iγmx} for all x∈[−1, 1] and C≥∥c∥₁. Then one can implement a unitary Ũ, which is ε close to a unitary

$${U : {\vert 0 〉}^{⊗ a} \to \frac{f ( x )}{C} \vert 0 〉}^{⊗ a} + γ \vert {Φ}^{⊥} 〉 , where \vert 0 〉 〈 0 {\vert}^{⊗ n} \vert {Φ}^{⊥} 〉 = 0 ,$$

using [symbol] (M+log(M) log(log(M)/ε)) queries to Oₓ, with the use of

[symbol]

(M+log(M)log(log(M)/ε))

additional two-qubit gates and a= [symbol] (log(M)+log log(log(M)/ε)) additional ancilla qubits.

### Proof.

This is a direct corollary of Lemma 3 and Lemma 7. □

For a sufficiently regular function ƒ one can usually find an ε-precise Fourier series, which uses powers only up to M= [symbol] (log(1/ε)), using for example the techniques of Lemma 37 in Joran van Apeldoorn et al., “Quantum SDP-Solvers: Better upper and lower bounds,” arxiv 1705.01843v1 (2017). For such a function the above result implies that one can construct an ε-precise amplitude oracle for ƒ(p)/∥ƒ∥_{∞} with a [symbol] (log(1/ε) log log(1/ε)) overhead in query and gate complexity with the use of [symbol] (log log(1/ε)) additional qubits.

As a trivial example one can use the identity function on [−½, ½]. As Lemma 37 of Joran van Apeldoorn et al., “Quantum SDP-Solvers: Better upper and lower bounds,” arxiv 1705.01843v1 (2017), shows, for every ε∈[0, ½] there exists M= [symbol] (log(1/ε)) and c∈ [symbol] ^{2M+1} such that for all

$$x ∈ [ - \frac{1}{2} , \frac{1}{2} ] \vert x - {\sum }_{m = - M}^{M} {c}_{m} {e}^{\frac{i π m}{2} x} \vert \leq ɛ$$

and ∥c∥₁≤1, so that the above discussion applies. The next subsection uses this observation.

III.D Linear Combination of Phases

Suppose one has a unitary U:|\vec{0} [symbol] →Σₖ₊₁^{N}βₖ|k [symbol] , where ∥α∥₂=1. If one has a phase oracle O_{\vec{x}}, such that

$$\vec{x} ∈ {[ - \frac{1}{2} , \frac{1}{2} ]}^{N}$$

then one can implement a unitary \tilde{V}, which is ε-close to

$$V : \vert \vec{0} 〉 \vert \vec{0} 〉 \to {\sum }_{k ∈ [ N ]} {α}_{k} \vert k 〉 {x}_{k} \vert \vec{0} 〉 + γ \vert {Φ}^{⊥} 〉 , where \vert I ⊗ \vert \vec{0} 〉 〈 \vec{0} \vert ) . \qquad ( 18 )$$

Moreover, one can implement \tilde{V} with 1 use of U and [symbol] (log(ε) log log(ε)) uses of O_{\vec{x}}. (One can simply use U followed by the ε-approximate implementation of the xₖ function as discussed above, since the same function is applied on each coordinate, one can perform it in superposition for each k.) One can then use \tilde{V} to implement an approximate phase oracle

$${O}_{Re ( {\sum }_{j = 1}^{N} {α}_{j} {x}_{j} ) / \sqrt{N}}$$

using Corollary 11 for calculating inner product between this state and Σₖ₌₁^{N}|k [symbol] |0 [symbol] /\sqrt{N}.

Also one can view (18) as a way to prepare quantum states whose parameters are (at least partially) described by numbers encoded in phase oracles. This might be useful for the implementation of several quantum algorithms, including the implementation of Szegedy type quantum walks and thereby Hamiltonian simulation and the HHL algorithm. See, e.g., Mario Szegedy, “The Lovász Local Lemma—A Survey,” Computer Science—Theory and Applications—Proceedings of the 8th International Computer Science Symposium in Russia, pgs. 1-11 (2013); Dominic W. Berry et al., “Hamiltonian Simulation with Nearly Optimal Dependence on all Parameters,” IEEE 56th Annual Symposium on Foundations of Computer Science, pgs. 792-809 (2015); and Andrew M. Childs et al., “Quantum linear systems algorithm with exponentially improved dependence on precision,” arxiv 1511.02306 (2015).

### IV. Further Embodiments for Implementing Phase Arithmetic

In this section, example methods for implementing phase arithmetic in a quantum computing device using embodiments of the disclosed technology are disclosed. The particular embodiments described should not be construed as limiting, as the disclosed method acts can be performed alone, in different orders, or at least partially simultaneously with one another. Further, any of the disclosed methods or method acts can be performed with any other methods or method acts disclosed herein.

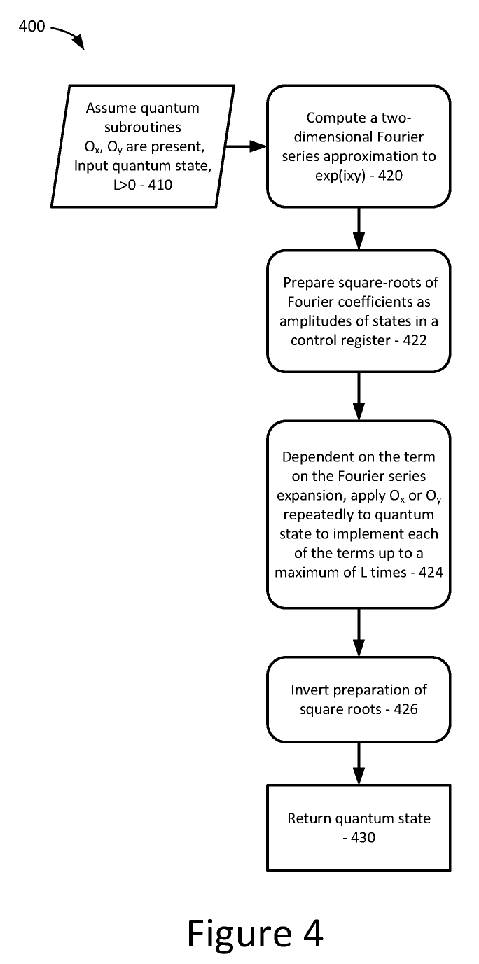

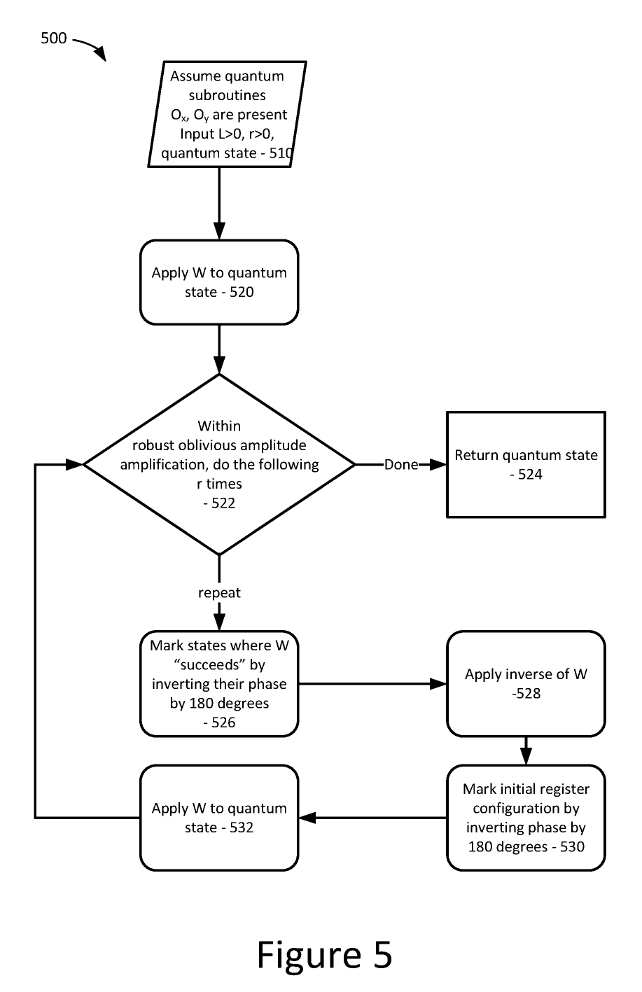

FIG. 4 is a flow chart showing an example method 400 for performing a linear combination of unitaries. For purposes of FIGS. 5-7, the method shown in FIG. 4 is termed “W”. Further, upon measuring the control register to be “0”, the method can enact the desired fourier series.

At 410, a quantum state is input. Further, in this example, quantum subroutines O_x, O_y are present.

At 420, a two-dimensional Fourier series approximation to exp(ixy) is computed.

At 422, square-roots of Fourier coefficients are prepared as amplitudes of states in a control register.

At 424, dependent on the term on the Fourier series expansion, O_x, O_y are applied repeatedly to quantum state to implement each of the terms up to a maximum of L times.

At 426, preparation of square roots is inverted.

At 430, a quantum state is returned (e.g., via a suitable read-out mechanism).

The method can be performed by one or more computer-readable media storing computer-executable instructions, which when executed by a classical computer cause the classical computer to perform the method of FIG. 4. Further, the method can be performed by a quantum computing system. In such embodiments, the quantum computing system, comprises a quantum computing device comprising a quantum circuit; and a classical computing device in communication with the quantum computing device and adapted to perform the method of FIG. 4.

FIG. 5 is a flow chart showing how linear combinations of unitary circuits (LCU) (as provided by FIG. 4) can be used for multiplication. In certain implementations, choosing r=9 is desirable for this protocol. The same protocol works for multiplying multiple input phases.

At 510, the quantum state from the result of the method “W” of 400 is input. As above, quantum subroutines O_x, O_y are present. Further, in this example, L>0 and r>0.

At 520, the routine of 400 (shown in FIG. 4 and sometimes referred to as “W”) is applied to the quantum state.

At 522, a determination is made as to whether robust oblivious amplitude amplification has been performed r times. If so, then at 524, the quantum state is returned (e.g., via a suitable read-out mechanism). If not, then a repeat process is performed. In particular, at 526, states where W “succeeds” are marked by inverting their phase by 180 degrees; at 528, the inverse of W is applied; at 530, an initial register configuration is marked by inverting phase by 180 degrees; and at 532, W is applied to the quantum state, and the process at 522 is repeated.

The method can be performed by one or more computer-readable media storing computer-executable instructions, which when executed by a classical computer cause the classical computer to perform the method of FIG. 5. Further, the method can be performed by a quantum computing system. In such embodiments, the quantum computing system, comprises a quantum computing device comprising a quantum circuit; and a classical computing device in communication with the quantum computing device and adapted to perform the method of FIG. 5.

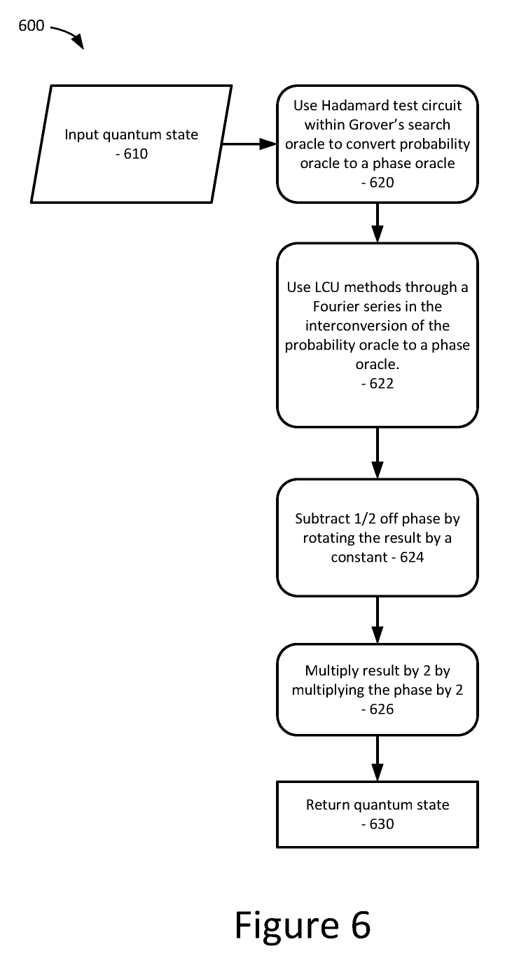

FIG. 6 is flow chart showing an example method 600 for computing the real part of the expectation value of a function. The imaginary part can be found by applying a phase shift to the unitary matrix being examined. The result is output as a phase, which can be estimated if needed by phase estimation or used as input to further quantum algorithms.

At 610, a quantum state is input.

At 620, a Hadamard test circuit within Grover's search oracle is used to convert probability oracle to a phase oracle.

At 622, LCU methods are used through a Fourier series decomposition to convert phases to reduce the exponent to an affine function of the real part of the expectation value.

At 624, “1” is subtracted off phase by rotating the result by a constant.

At 626, the result is divided by “2” by multiplying the phase by “½”.

At 630, a current quantum state is returned (e.g., via a suitable read-out mechanism).

The method can be performed by one or more computer-readable media storing computer-executable instructions, which when executed by a classical computer cause the classical computer to perform the method of FIG. 6. Further, the method can be performed by a quantum computing system. In such embodiments, the quantum computing system, comprises a quantum computing device comprising a quantum circuit; and a classical computing device in communication with the quantum computing device and adapted to perform the method of FIG. 6.

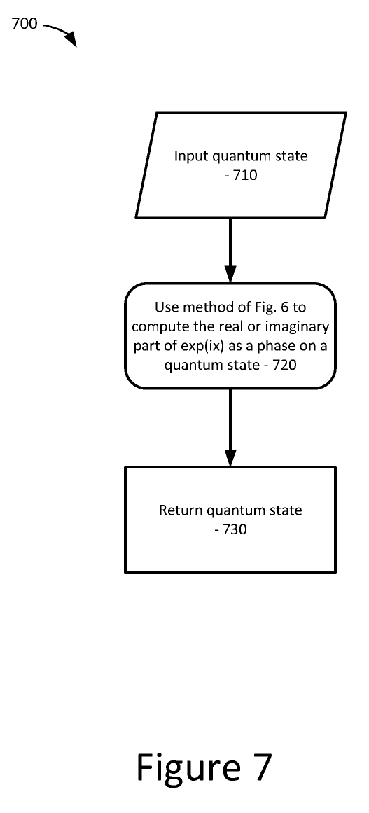

FIG. 7 is a flow chart showing an example method 700 for computing elementary trigonometric functions (using the method of FIG. 6) and outputting result as a phase.

At 710, a quantum state is input.

At 720, method 600 of FIG. 6 is used to compute the real or imaginary part of exp(ix) as a phase on a quantum state.

At 730, a current quantum state is returned (e.g., via a suitable read-out mechanism).

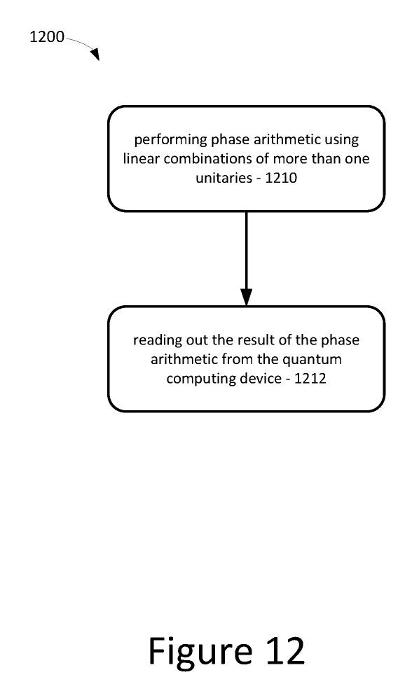

FIG. 12 is a flow chart showing a general method for performing embodiments of the disclosed technology.

At 1210, in a quantum computing device, phase arithmetic is performed using linear combinations of more than one unitaries.

At 1212, the result of the phase arithmetic from the quantum computing device is read out.

In certain implementations, the performing phase arithmetic is performed without using a repeat-until-success process or circuit. In further implementations, the phase arithmetic comprises a smooth multi-variable function. In some implementations, the phase arithmetic comprises a multiplication function of two phases. In certain implementations, the phase arithmetic comprises a multiplication function of a phase with a fixed real number. In further implementations, phase estimation is used to output the phase as a bit string. In some implementations, the function to be computed represents the classification output by a quantum neural network. In further implementations, the functions computed represent part of or the entirety of the kinetic or potential energy of a quantum system within a quantum simulation.

The method can be performed by one or more computer-readable media storing computer-executable instructions, which when executed by a classical computer cause the classical computer to perform the method of FIG. 12.

Further, the method can be performed by a quantum computing system. In such embodiments, the quantum computing system, comprises a quantum computing device comprising a quantum circuit; and a classical computing device in communication with the quantum computing device and adapted to perform a method, the method comprising: performing phase arithmetic in the quantum computing device using linear combinations of more than one unitaries; and reading out the result of the phase arithmetic from the quantum computing device.

In certain implementations, the performing phase arithmetic is performed without using a repeat-until-success process or circuit. In further implementations, the phase arithmetic comprises a smooth multi-variable function. In some implementations, the phase arithmetic comprises a multiplication function of two phases. In certain implementations, the phase arithmetic comprises a multiplication function of a phase with a fixed real number. In further implementations, phase estimation is used to output the phase as a bit string. In some implementations, the function to be computed represents the classification output by a quantum neural network. In further implementations, the functions computed represent part of or the entirety of the kinetic or potential energy of a quantum system within a quantum simulation.

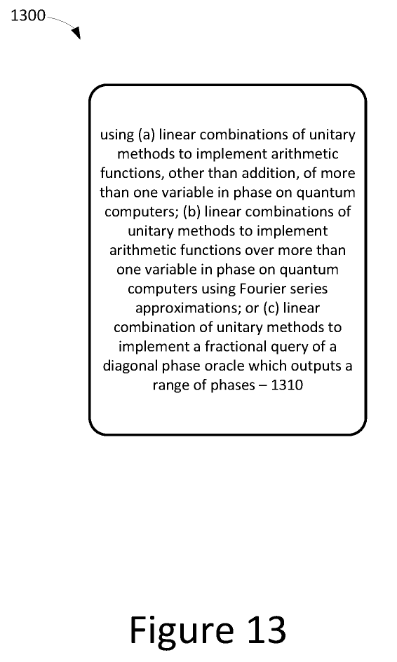

FIG. 13 is a flow chart showing a further general method for performing embodiments of the disclosed technology.

At 1300, a method for performing operations in a quantum computing device is performed, wherein the method comprises using (a) linear combinations of unitary methods to implement arithmetic functions, other than addition, of more than one variable in phase in the quantum computing device; (b) linear combinations of unitary methods to implement arithmetic functions over more than one variable in phase in the quantum computing device using Fourier series approximations; or (c) linear combination of unitary methods in the quantum computing device to implement a fractional query of a diagonal phase oracle which outputs a range of phases.

In certain implementations, the method comprises using (a) or (b) to implement generic smooth functions of many variables in phase on quantum computers. Further, in some implementations, the method comprises using (c).

### V. Example Computing Environments

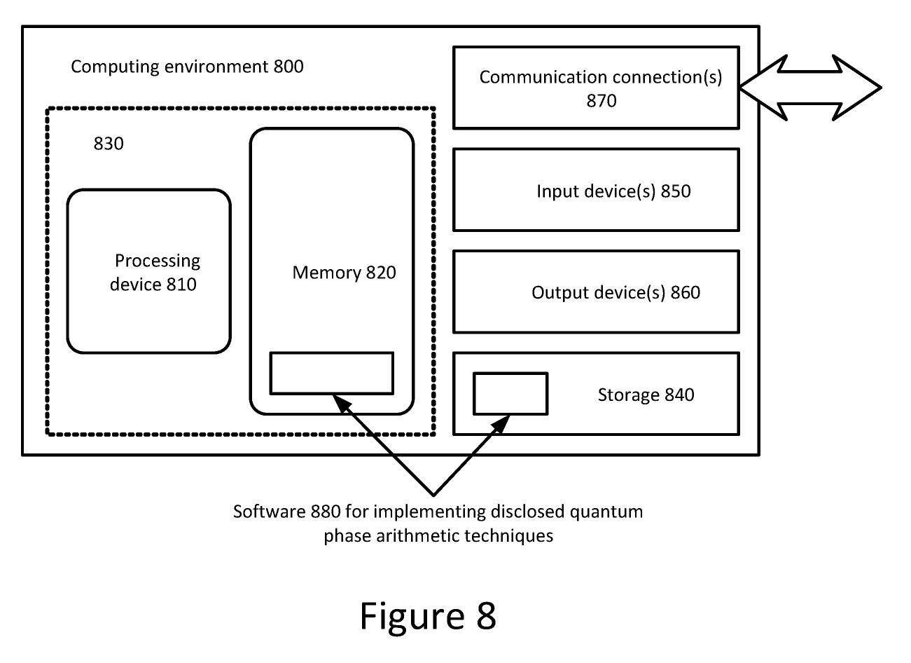

FIG. 8 illustrates a generalized example of a suitable classical computing environment 800 in which aspects of the described embodiments can be implemented. The computing environment 800 is not intended to suggest any limitation as to the scope of use or functionality of the disclosed technology, as the techniques and tools described herein can be implemented in diverse general-purpose or special-purpose environments that have computing hardware.

With reference to FIG. 8, the computing environment 800 includes at least one processing device 810 and memory 820. In FIG. 8, this most basic configuration 830 is included within a dashed line. The processing device 810 (e.g., a CPU or microprocessor) executes computer-executable instructions. In a multi-processing system, multiple processing devices execute computer-executable instructions to increase processing power. The memory 820 may be volatile memory (e.g., registers, cache, RAM, DRAM, SRAM), non-volatile memory (e.g., ROM, EEPROM, flash memory), or some combination of the two. The memory 820 stores software 880 implementing tools for performing any of the disclosed techniques for operating a quantum computer to perform phase arithmetic in the quantum computer as described herein. The memory 820 can also store software 880 for synthesizing, generating, or compiling quantum circuits for performing the described phase arithmetic techniques as described herein.

The computing environment can have additional features. For example, the computing environment 800 includes storage 840, one or more input devices 850, one or more output devices 860, and one or more communication connections 870. An interconnection mechanism (not shown), such as a bus, controller, or network, interconnects the components of the computing environment 800. Typically, operating system software (not shown) provides an operating environment for other software executing in the computing environment 800, and coordinates activities of the components of the computing environment 800.

The storage 840 can be removable or non-removable, and includes one or more magnetic disks (e.g., hard drives), solid state drives (e.g., flash drives), magnetic tapes or cassettes, CD-ROMs, DVDs, or any other tangible non-volatile storage medium which can be used to store information and which can be accessed within the computing environment 800. The storage 840 can also store instructions for the software 880 implementing any of the disclosed techniques for performing phase arithmetic in a quantum computing device. The storage 840 can also store instructions for the software 880 for generating and/or synthesizing any of the described techniques, systems, or quantum circuits.

The input device(s) 850 can be a touch input device such as a keyboard, touchscreen, mouse, pen, trackball, a voice input device, a scanning device, or another device that provides input to the computing environment 800. The output device(s) 860 can be a display device (e.g., a computer monitor, laptop display, smartphone display, tablet display, netbook display, or touchscreen), printer, speaker, or another device that provides output from the computing environment 800.

The communication connection(s) 870 enable communication over a communication medium to another computing entity. The communication medium conveys information such as computer-executable instructions or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

As noted, the various methods, techqniues for controlling a quantum computing device to perform phase arithmetic, circuit design techniques, or compilation/synthesis techniques can be described in the general context of computer-readable instructions stored on one or more computer-readable media. Computer-readable media are any available media (e.g., memory or storage device) that can be accessed within or by a computing environment. Computer-readable media include tangible computer-readable memory or storage devices, such as memory 820 and/or storage 840, and do not include propagating carrier waves or signals per se (tangible computer-readable memory or storage devices do not include propagating carrier waves or signals per se).

Various embodiments of the methods disclosed herein can also be described in the general context of computer-executable instructions (such as those included in program modules) being executed in a computing environment by a processor. Generally, program modules include routines, programs, libraries, objects, classes, components, data structures, and so on, that perform particular tasks or implement particular abstract data types. The functionality of the program modules may be combined or split between program modules as desired in various embodiments. Computer-executable instructions for program modules may be executed within a local or distributed computing environment.

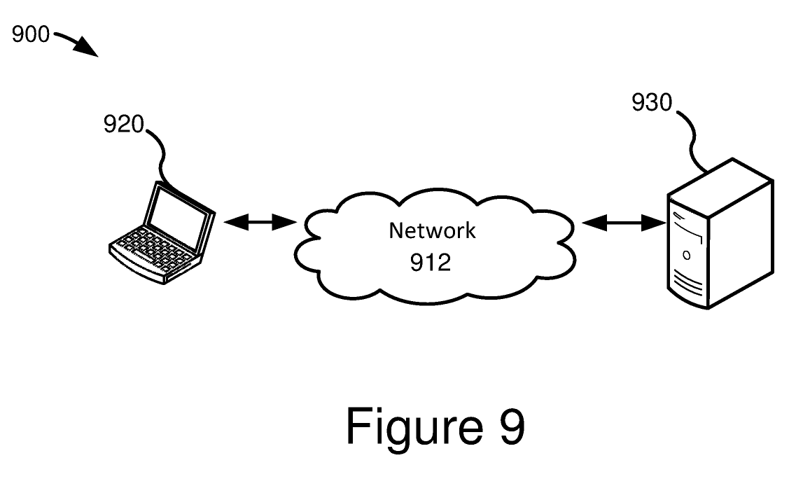

An example of a possible network topology 900 (e.g., a client-server network) for implementing a system according to the disclosed technology is depicted in FIG. 9. Networked computing device 920 can be, for example, a computer running a browser or other software connected to a network 912. The computing device 920 can have a computer architecture as shown in FIG. 8 and discussed above. The computing device 920 is not limited to a traditional personal computer but can comprise other computing hardware configured to connect to and communicate with a network 912 (e.g., smart phones, laptop computers, tablet computers, or other mobile computing devices, servers, network devices, dedicated devices, and the like). Further, the computing device 920 can comprise an FPGA or other programmable logic device. In the illustrated embodiment, the computing device 920 is configured to communicate with a computing device 930 (e.g., a remote server, such as a server in a cloud computing environment) via a network 912. In the illustrated embodiment, the computing device 920 is configured to transmit input data to the computing device 930, and the computing device 930 is configured to implement a technique for controlling a quantum computing device to perform phase arithmetic according to any of the disclosed embodiments and/or a circuit generation/compilation/synthesis technique for generating quantum circuits for performing any of the phase arithmetic techniques disclosed herein. The computing device 930 can output results to the computing device 920. Any of the data received from the computing device 930 can be stored or displayed on the computing device 920 (e.g., displayed as data on a graphical user interface or web page at the computing devices 920). In the illustrated embodiment, the illustrated network 912 can be implemented as a Local Area Network (“LAN”) using wired networking (e.g., the Ethernet IEEE standard 802.3 or other appropriate standard) or wireless networking (e.g. one of the IEEE standards 802.11a, 802.11b, 802.11g, or 802.11n or other appropriate standard). Alternatively, at least part of the network 912 can be the Internet or a similar public network and operate using an appropriate protocol (e.g., the HTTP protocol).

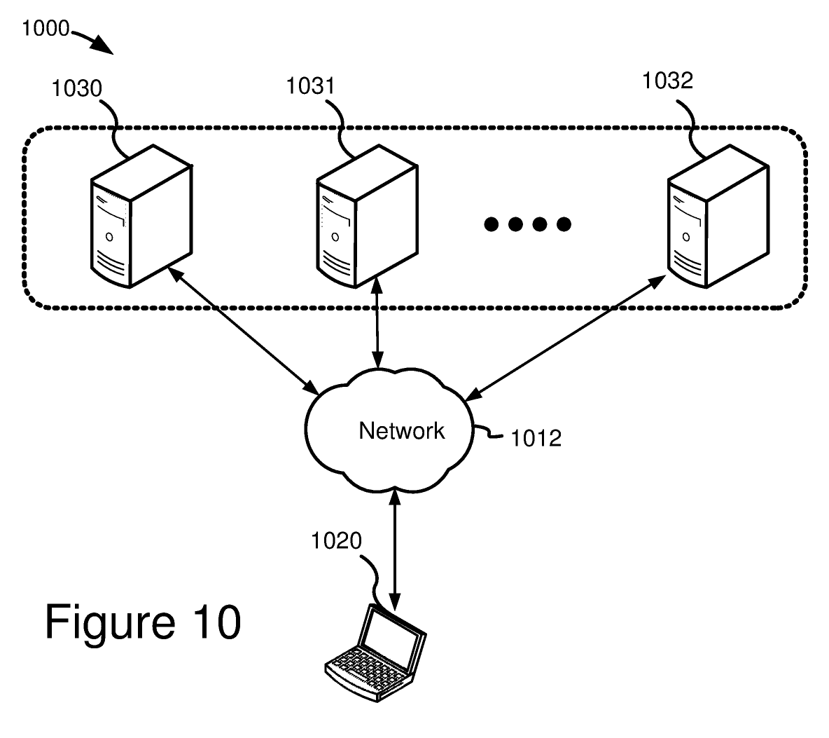

Another example of a possible network topology 1000 (e.g., a distributed computing environment) for implementing a system according to the disclosed technology is depicted in FIG. 10. Networked computing device 1020 can be, for example, a computer running a browser or other software connected to a network 1012. The computing device 1020 can have a computer architecture as shown in FIG. 8 and discussed above. In the illustrated embodiment, the computing device 1020 is configured to communicate with multiple computing devices 1030, 1031, 1032 (e.g., remote servers or other distributed computing devices, such as one or more servers in a cloud computing environment) via the network 1012. In the illustrated embodiment, each of the computing devices 1030, 1031, 1032 in the computing environment 1000 is used to perform at least a portion of a technique for controlling a quantum computing device to perform phase arithmetic according to any of the disclosed embodiments and/or a circuit generation/compilation/synthesis technique for generating quantum circuits for performing any of the phase arithmetic techniques disclosed herein. In other words, the computing devices 1030, 1031, 1032 form a distributed computing environment in which aspects of the techniques for performing phase arithmetic in a quantum computing device as disclosed herein and/or quantum circuit generation/compilation/synthesis processes are shared across multiple computing devices. The computing device 1020 is configured to transmit input data to the computing devices 1030, 1031, 1032, which are configured to distributively implement such as process, including performance of any of the disclosed methods or creation of any of the disclosed circuits, and to provide results to the computing device 1020. Any of the data received from the computing devices 1030, 1031, 1032 can be stored or displayed on the computing device 1020 (e.g., displayed as data on a graphical user interface or web page at the computing devices 1020). The illustrated network 1012 can be any of the networks discussed above with respect to FIG. 9.

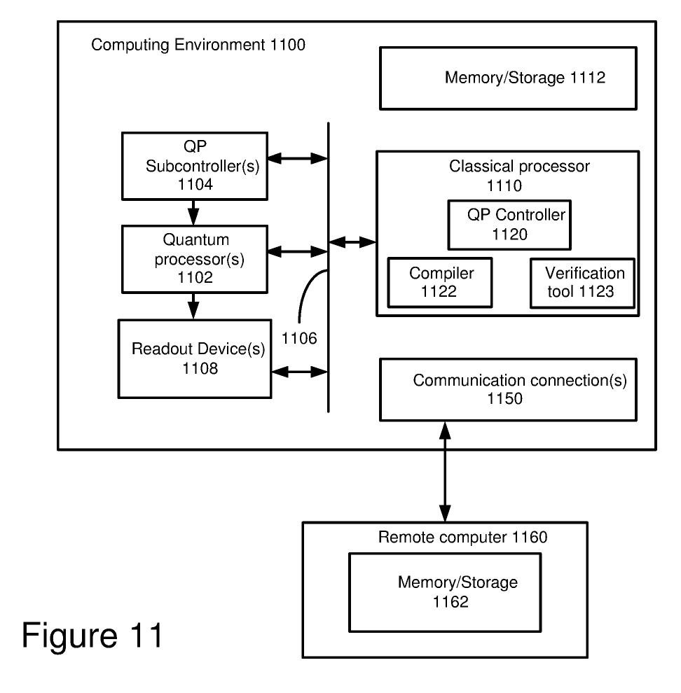

With reference to FIG. 11, an exemplary system for implementing the disclosed technology includes computing environment 1100. In computing environment 1100, a compiled quantum computer circuit description (including quantum circuits for performing any of the disclosed phase arithmetic techniques as disclosed herein) can be used to program (or configure) one or more quantum processing units such that the quantum processing unit(s) implement the circuit described by the quantum computer circuit description (and thus the desired phase arithmetic).

The environment 1100 includes one or more quantum processing units 1102 and one or more readout device(s) 1108. The quantum processing unit(s) execute quantum circuits that are precompiled and described by the quantum computer circuit description. The quantum processing unit(s) can be one or more of, but are not limited to: (a) a superconducting quantum computer; (b) an ion trap quantum computer; (c) a fault-tolerant architecture for quantum computing; and/or (d) a topological quantum architecture (e.g., a topological quantum computing device using Majorana zero modes). The precompiled quantum circuits, including any of the disclosed circuits, can be sent into (or otherwise applied to) the quantum processing unit(s) via control lines 1106 at the control of quantum processor controller 1120. The quantum processor controller (QP controller) 1120 can operate in conjunction with a classical processor 1110 (e.g., having an architecture as described above with respect to FIG. 8) to implement the desired quantum computing process. In the illustrated example, the QP controller 1120 further implements the desired quantum computing process via one or more QP subcontrollers 1104 that are specially adapted to control a corresponding one of the quantum processor(s) 1102. For instance, in one example, the quantum controller 1120 facilitates implementation of the compiled quantum circuit by sending instructions to one or more memories (e.g., lower-temperature memories), which then pass the instructions to low-temperature control unit(s) (e.g., QP subcontroller(s) 1104) that transmit, for instance, pulse sequences representing the gates to the quantum processing unit(s) 1102 for implementation. In other examples, the QP controller(s) 1120 and QP subcontroller(s) 1104 operate to provide appropriate magnetic fields, encoded operations, or other such control signals to the quantum processor(s) to implement the operations of the compiled quantum computer circuit description. The quantum controller(s) can further interact with readout devices 1108 to help control and implement the desired quantum computing process (e.g., by reading or measuring out data results from the quantum processing units once available, etc.)

With reference to FIG. 11, compilation is the process of translating a high-level description of a quantum algorithm into a quantum computer circuit description comprising a sequence of quantum operations or gates, which can include the circuits as disclosed herein (e.g., the circuits configured to perform one or more phase arithmetic procedures as disclosed herein). The compilation can be performed by a compiler 1122 using a classical processor 1110 (e.g., as shown in FIG. 8) of the environment 1100 which loads the high-level description from memory or storage devices 1112 and stores the resulting quantum computer circuit description in the memory or storage devices 1112.

In other embodiments, compilation and/or verification can be performed remotely by a remote computer 1160 (e.g., a computer having a computing environment as described above with respect to FIG. 8) which stores the resulting quantum computer circuit description in one or more memory or storage devices 1162 and transmits the quantum computer circuit description to the computing environment 1100 for implementation in the quantum processing unit(s) 1102. Still further, the remote computer 1100 can store the high-level description in the memory or storage devices 1162 and transmit the high-level description to the computing environment 1100 for compilation and use with the quantum processor(s). In any of these scenarios, results from the computation performed by the quantum processor(s) can be communicated to the remote computer after and/or during the computation process. Still further, the remote computer can communicate with the QP controller(s) 1120 such that the quantum computing process (including any compilation, verification, and QP control procedures) can be remotely controlled by the remote computer 1160. In general, the remote computer 1160 communicates with the QP controller(s) 1120, compiler/synthesizer 1122, and/or verification tool 1123 via communication connections 1150.

In particular embodiments, the environment 1100 can be a cloud computing environment, which provides the quantum processing resources of the environment 1100 to one or more remote computers (such as remote computer 1160) over a suitable network (which can include the internet).

### VI. Appendix

In this appendix, techniques are presented based on ideas used for Hamiltonian simulation. See Andrew M. Childs et al., “Quantum linear systems algorithm with exponentially improved dependence on precision,” arxiv 1511.02306 (2015). The basic ideas are already known from the literature, but here they are slightly generalized and improved upon in order to improve the disclosed phase arithmetics applications.

### Lemma 14 (General LCU Lemma)

Suppose that A, B are unitaries acting on the Hilbert space [symbol] ^{M} such that A:|0 [symbol] →Σ_{m∈[M]}αₘ|m [symbol] , B:|0 [symbol] →Σ_{m∈[M]}βₘ|m [symbol] , and suppose that Uₘ is a unitary acting on the Hilbert space [symbol] for all m∈[M]. If U=Σ_{m∈[M]}|m [symbol] [symbol] m|└Uₘ and

$$L = {\sum }_{m = - M}^{M} ( {β}_{m}^{*} {α}_{m} ) {U}^{m} ,$$

then the unitary C=(B^{†}⊗I)U(A⊗I) acts for every |ψ [symbol] ∈ [symbol] as

C:|0 [symbol] |ψ [symbol] →|0 [symbol] L|ψ [symbol] +γ|Φ^{⊥} [symbol] ,

where (|0 [symbol] [symbol] 0|⊗I)|Φ^{⊥} [symbol] =0 and |Φ^{⊥} [symbol] , γ∈[0, 1] might depend on the particular |ψ [symbol] .

### Proof.

$$\begin{matrix}( \vert 0 〉 〈 0 \vert ⊗ I ) C \vert 0 〉 \vert ψ 〉 = ( \vert 0 〉 〈 0 \vert {B}^{†} ⊗ I ) U ( A \vert 0 〉 \vert ψ 〉 ) \\ = ( \vert 0 〉 ( {\sum }_{m ∈ [ M ]}^{ } {β}_{m}^{*} 〈 m \vert ) ⊗ I ) \\ {\sum }_{m ∈ [ M ]}^{ } \vert m 〉 〈 m \vert ⊗ {U}_{m} ( ( {\sum }_{m ∈ [ M ]}^{ } {α}_{m} \vert m 〉 ) \vert ψ 〉 ) \\ = ( \vert 0 〉 ( {\sum }_{m ∈ [ M ]}^{ } {β}_{m}^{*} 〈 m \vert ) ⊗ I ) ( {\sum }_{m ∈ [ M ]}^{ } {α}_{m} \vert m 〉 {U}_{m} \vert ψ 〉 ) \\ = \vert 0 〉 {\sum }_{m ∈ [ M ]}^{ } ( {β}_{m}^{*} {α}_{m} ) {U}_{m} \vert ψ 〉 \\ = \vert 0 〉 L \vert ψ 〉 .\end{matrix}$$

Using the state preparation techniques of Vivek V. Shende, et. al., “Synthesis of quantum-logic circuits,” IEEE Trans. on CAD of Integrated Circuits and Systems, vol. 25, no. 6, pgs. 1000-1010 (2006) to construct the unitaries A, B in the above lemma one can prove the following variant of the LCU Lemma, which is suited for implementing functions represented by a Fourier series:

### Lemma 3 (Fourier LCU Lemma)

Suppose that β∈ [symbol] ^{2M+1}, ∥β∥₁≤B∈ [symbol] ₊ and U: [symbol] → [symbol] is a unitary, moreover L=Σ_{m=-M}^{M}βₘU^{M}. Let b=┌log₂(M+2)┐, then one can implement a unitary circuit C such that for all |ψ [symbol] ∈ [symbol] it acts as

$${{C \text{:} \vert ψ 〉 \vert 0 〉}^{⊗ a} \to \frac{L}{B} \vert ψ 〉 \vert 0 〉}^{⊕ a} + γ \vert {Φ}^{⊥} 〉 ,$$

where (I⊗|0 [symbol] [symbol] 0|^{⊗a})|Φ^{⊥} [symbol] =0, and γ∈[0, 1], |Φ^{⊥} [symbol] might be |ψ [symbol] -dependent. Moreover C can be implemented using a single application of the (controlled) U⁻²^{^{b}} gate and a single use of the (controlled) gates U²^{^{b−1}}, U²^{^{b−2}}, . . . , U¹ with using [symbol] (M) other two-qubit gates and a= [symbol] (log(M)) additional ancilla qubits.

### Proof.

Here, a signed binary (qu)bit representation is used for the integers in [2^{-b}, 2^{b}−1], Such that the (qu)bitstring (m_{b}m_{b-1} . . . m₀) represents the number m=−m_{b}2^{b}+Σᵥ₌₀^{b-1}mᵥ2^{v}. Let the sub-normalized state (in the definition of |α [symbol] any of two possible complex square roots work, one can choose arbitrarily) |α [symbol] =Σ_{m=-M}^{M} \sqrt{βₘ/B}, then one can construct unitaries A, A′ such that A:|0 [symbol] →|α [symbol] +\sqrt{1−\sqrt{∥β∥₁/B}}|M+1 [symbol] and A′:|0 [symbol] →|α [symbol] +\sqrt{1−\sqrt{∥β∥₁/B}}|−M−1 [symbol] , using [symbol] (2^{b})= [symbol] (M) two-qubit gate as shown by Vivek V. Shende, et. al., “Synthesis of quantum-logic circuits,” IEEE Trans. on CAD of Integrated Circuits and Systems, vol. 25, no. 6, pgs. 1000-1010 (2006). Finally the General LCU Lemma shows, that C can be implemented using the circuit in FIG. 3, which is a schematic block diagram 300 showing a quantum circuit for implementing a Fourier series of H=log(U).

Now the discussion turns to proving an improved analysis of robust oblivious amplitude amplification, which proves better approximation bounds. First, one can invoke Jordan's result on orthogonal projectors:

### Theorem 15 (Jordan's Theorem)

Let [symbol] be a finite dimensional complex Euclidian (e.g., Hilbert) space. If Π₁, Π₂ are orthogonal projectors acting on this space, then [symbol] can be decomposed to a direct sum of orthogonal subspaces

$$ℋ = {⊕}_{j ∈ [ J ]} {ℋ}_{j}^{( 1 )} ⊕ {⊕}_{k ∈ [ K ]} {ℋ}_{k}^{( 2 )} .$$

For all j∈|J|: [symbol] ⱼ⁽¹⁾=Span(|φⱼ [symbol] ) is a 1-dimensional subapace satisfying ∥Π₁|φ [symbol] ∥∈{0, 1}, ∥Π₂|φⱼ [symbol] ∥∈{0, 1}. For all k∈[K]: [symbol] ₖ⁽²⁾=Span(|ψₖ [symbol] , |ψₖ^{⊥} [symbol] )=Span(|ϕₖ [symbol] , |ϕₖ^{⊥} [symbol] ), is a 2-dimensional subspace satisfying Π₁|ψₖ [symbol] =|ψₖ [symbol] , Π₂|ϕₖ [symbol] =|ϕₖ [symbol] , Π₁|ψₖ^{⊥} [symbol] =0=Π₂|ϕₖ^{⊥} [symbol] , moreover | [symbol] ψₖ|ϕₖ [symbol] |∉{0, 1}.

Inspired by Kothari's “2D subspace lemma”, a generalization of Grover's search in terminology related to Jordan's result is proved.

### Lemma 16 (2D Subspace Lemma)

Let W be a unitary such that W|ψ=sin(θ)|ϕ [symbol] +cos(θ)|ϕ^{⊥} [symbol] , where [symbol] ϕ|ϕ^{⊥}=0. Suppose Π₁, Π₂ are orthogonal projectors, such that Π₂|ϕ [symbol] =|ϕ [symbol] and Π₂|ϕ^{⊥} [symbol] =0 and similarly Π₁|ψ [symbol] =|ψ [symbol] and Π₁W^{†}(cos(θ)|ϕ [symbol] −sin(θ)|ϕ^{⊥} [symbol] )=0. (Note that the requirements on Π₁ are not contradicting, because [symbol] ψ|W^{†}(cos(θ)|ϕ)−sin(θ)|ϕ^{⊥} [symbol] )=0.) Let G:=W(2Π₁−I)W^{†}(2Π₂−I), then

G^{k}W|ψ [symbol] =sin((2k+1)θ)|ϕ [symbol] +cos((2k+1)θ)|ϕ^{⊥} [symbol] .

### Proof.

Observe that the subspace V=Span(|ϕ [symbol] , |ϕ^{⊥} [symbol] ) is invariant under both (2ﬂ₂−I) and W(2Π₁−I)W^{†}, therefore it is also invariant under G. Moreover on this subspace G acts a product of two reflections, therefore it is a rotation. It is easy to verify, that its angle of rotation is indeed 2θ. □

Now one can prove an improved error bound on robust oblivious amplitude amplification.

### Lemma 4 (Generic Robust Oblivious Amplitude Amplification)

Let r∈ [symbol] ₊, ε∈[0, ½], Π₁, Π₂ orthogonal projectors and W a unitary such that for all |ψ [symbol] ∈Im(Π₁) it satisfies

$$‖ {Π}_{2} W \vert ψ 〉 ‖ ∈ [ sin ( \frac{π / 2}{2 r + 1} ) ( 1 - ɛ ) , sin ( \frac{π / 2}{2 r + 1} ) ( 1 + ɛ ) ] . \qquad ( 1 )$$

Let G:=W(2Π₁−I)W^{†}(2Π₂−I), then for all |ψ [symbol] ∈Im(Π₁)

$$‖ {G}^{r} W \vert ψ 〉 - \frac{{Π}_{2} W \vert ψ 〉}{sin ( \frac{π / 2}{2 r + 1} )} ‖ \leq \frac{7}{2} ɛ .$$

or in other words

$$‖ {G}^{r} W {Π}_{1} - \frac{{Π}_{2} W {Π}_{1}}{sin ( \frac{π / 2}{2 r + 1} )} ‖ \leq \frac{7}{2} ɛ ,$$

### Proof.

Let \tilde{Π}₁:=WΠ₁W^{†}. One can apply Jordan's Theorem 15 on the projectors \tilde{Π}₁, Π₂ to decompose [symbol] to 1 and 2 dimensional subspaces. By (1) one knows that for each |φ [symbol] ∈Im(WΠ₁W^{†}) one has ∥Π₂|φ [symbol] ∥∈(0, 1), and thus no |φ [symbol] ∈Im(WΠ₁W^{†}) can satisfy ∥Π₂|φ [symbol] ∥∈{0, 1}. Therefore using the notation of Theorem 15, one knows that

$$Im ( W {Π}_{1} {W}^{†} ) = {Span}_{k ∈ K} \{ \vert {ψ}_{k} 〉 \} .$$

Let |\tilde{ψ}ₖ [symbol] :=W^{†}|ψₖ [symbol] and θₖ=arcsin(∥Π₂W|\tilde{ψ}ₖ [symbol] ∥), then one can assume without loss of generality that W|\tilde{ψ}ₖ [symbol] =sin(θₖ)|ϕₖ [symbol] +cos(θₖ)|ϕₖ^{⊥} [symbol] , because in the definition [symbol] ₖ⁽²⁾=Span(|ϕₖ [symbol] , |ϕₖ^{⊥} [symbol] ) one can multiply the vectors with a unit length complex number (phase). This shows that that |\tilde{ψ}ₖ [symbol] , θₖ satisfy the requirements of Lemma 16, and so

G^{k}W|\tilde{ψ}ₖ [symbol] =sin((2r+1)θₖ)|ϕₖ [symbol] +cos((2r+1)θₖ)|ϕₖ^{⊥} [symbol] .

### Let

$$\vert {υ}_{k} 〉 := {G}^{r} W \vert {\tilde{ψ}}_{k} 〉 - \frac{{Π}_{2} W}{sin ( \frac{π / 2}{2 r + 1} )} \vert {\tilde{ψ}}_{k} 〉 .$$

it is easy to see that |vₖ [symbol] ∈ [symbol] ₖ⁽²⁾, moreover

$$\begin{matrix}‖ {υ}_{k} ‖ = ‖ {G}^{r} W \vert {\tilde{ψ}}_{k} 〉 - \frac{{Π}_{2} W \vert {\tilde{ψ}}_{k} 〉}{sin ( \frac{π / 2}{2 r + 1} )} ‖ \leq \\ ‖ {G}^{r} W \vert {\tilde{ψ}}_{k} 〉 - \vert {φ}_{k} 〉 ‖ + ‖ \vert {φ}_{k} 〉 - \frac{{Π}_{2} W \vert {\tilde{ψ}}_{k} 〉}{sin ( \frac{π / 2}{2 r + 1} )} ‖ \\ = ‖ sin ( ( 2 r + 1 ) {θ}_{k} ) \vert {φ}_{k} 〉 + cos ( ( 2 r + 1 ) {θ}_{k} ) \vert {θ}_{k}^{⊥} 〉 - \vert {φ}_{k} 〉 ‖ + \\ ‖ \vert {φ}_{k} 〉 - \frac{‖ {Π}_{2} W \vert {\tilde{ψ}}_{k} 〉 ‖}{sin ( \frac{π / 2}{2 r + 1} )} \vert {φ}_{k} 〉 ‖ \leq \\ \vert ( 2 r + 1 ) {θ}_{k} - \frac{π}{2} \vert + ɛ \\ = ( 2 r + 1 ) {max}_{\pm } \vert arcsin ( sin ( \frac{π / 2}{2 r + 1} ) ( 1 + ɛ ) ) - \frac{π / 2}{2 r + 1} \vert + ɛ .\end{matrix}$$

Next let arcsin ′ be the derivative of arcsin. It then follows from the fact that arcsin ′ is monotonically increasing on [0, 1) that ∥vₖ∥ is bounded above by

$$( 2 r + 1 ) \vert {arcsin}^{′} ( sin ( \frac{π / 2}{2 r + 1} ) ( 1 + ɛ ) ) ɛ sin ( \frac{π / 2}{2 r + 1} ) \vert + ɛ \leq ( 2 r + 1 ) \vert ( \frac{4}{\sqrt{7}} ) ɛ ( \frac{π / 2}{2 r + 1} ) \vert + ɛ \leq \frac{7}{2} ɛ ,$$

where above one can use the fact that sin(π/2/[2r+1])(1+ϵ)≤sin(π/2/[2r+1])(3/2)≤¾ since r≥1 and that |sin(x)|≤|x|.

Now one can turn to to the general case. Suppose |ψ [symbol] ∈Im(Π₁), then one can decompose it as |ψ [symbol] =Σ_{k∈[K]}λₖ|\tilde{ψ}ₖ [symbol] such that ∥λ∥=|∥ψ [symbol] ∥=1. Then

$$‖ {G}^{r} W \vert ψ 〉 - \frac{{Π}_{2} W \vert ψ 〉}{sin ( \frac{π / 2}{2 r + 1} )} ‖ = ‖ {\sum }_{k ∈ [ K ]}^{ } {λ}_{k} \vert {υ}_{k} 〉 ‖ = \sqrt{{\sum }_{k ∈ [ K ]}^{ } {λ}_{k}^{2} {‖ \vert {υ}_{k} 〉 ‖}^{2}} \leq ‖ λ ‖ \frac{7}{2} ɛ = \frac{7}{2} ɛ .$$

Note that in the second step, |vₖ [symbol] ∈ [symbol] ₖ⁽²⁾ were used, which are orthogonal subspaces for each k∈[K]. □

### VII. Concluding Remarks

In this disclosure, a new class of phase arithmetic has been provided that explicitly uses linear combinations of unitaries (LCU) methods to approximate an arbitrary analytic function on the phases output by unknown diagonal quantum circuits (which are referred to as phase oracles). Unlike existing phase arithmetic approaches, embodiments of the disclosed techniques run in time that is polynomial in the number of bits of precision required and furthermore require fewer (e.g., minimal) qubit overheads. These methods are significant because they allow one to post-process data that comes back from phase kickback circuits without needing to cache the results in qubits through amplitude estimation. In some cases, such ideas can lead to exponentially better scaling of algorithms with respect to the number of bits of precision required because of the overheads of phase estimation. This work is especially significant in cases when the functions that are wished to be applied are multi-variate wherein the results can be used to generalize existing methods from both the LCU literature and the quantum signal processing literature, Low et al “Optimal Hamiltonian simulation by quantum signal processing.” Physical review letters 118.1 pgs. 010501 (2017) and Low et al “Hamiltonian simulation by uniform spectral amplification.” arXiv preprint arXiv:1707.05391 (2017), for performing functions of input phases considerably.

Further, the techniques that are disclosed here are useful in implementing the arithmetic needed to set the phases properly in linear-combinations circuits (e.g., as used in quantum chemistry simulations). This end-to-end version of quantum chemistry not only promises to reduce the time complexity of simulations but also promises to make such schemes simpler by allowing the entire protocol to be performed within an LCU framework. The generality of the disclosed technology allows these methods to applied more broadly than chemistry simulation and also may be useful as an oracle replacement technique in quantum linear-systems algorithms and elsewhere in quantum machine learning.

Having described and illustrated the principles of the disclosed technology with reference to the illustrated embodiments, it will be recognized that the illustrated embodiments can be modified in arrangement and detail without departing from such principles. For instance, elements of the illustrated embodiments shown in software may be implemented in hardware and viceversa. Also, the technologies from any example can be combined with the technologies described in any one or more of the other examples. It will be appreciated that procedures and functions such as those described with reference to the illustrated examples can be implemented in a single hardware or software module, or separate modules can be provided. The particular arrangements above are provided for convenient illustration, and other arrangements can be used.

1. A method, comprising:
in a quantum computing device, performing phase arithmetic using linear combinations of more than one unitaries; and
reading out the result of the phase arithmetic from the quantum computing device.

2. The method of claim 1, wherein the phase arithmetic is performed without using a repeat-until-success process or circuit.

3. The method of claim 1, wherein the phase arithmetic comprises a smooth multi-variable function.

4. The method of claim 1, wherein the phase arithmetic comprises a multiplication function of two phases.

5. The method of claim 1, wherein the phase arithmetic comprises a multiplication function of a phase with a fixed real number.

6. The method of claim 1, wherein phase estimation is used to output the phase as a bit string.

7. The method of claim 1, wherein the function to be computed represents the classification output by a quantum neural network.

8. The method of claim 1, wherein the functions computed represent part of or the entirety of the kinetic or potential energy of a quantum system within a quantum simulation.

9. One or more computer-readable media storing computer-executable instructions, which when executed by a classical computer cause the classical computer to perform the method of claim 1.

10. A quantum computing system, comprising:
a quantum computing device comprising a quantum circuit; and
a classical computing device in communication with the quantum computing device and adapted to perform a method, the method comprising:
performing phase arithmetic in the quantum computing device using linear combinations of more than one unitaries; and
reading out the result of the phase arithmetic from the quantum computing device.

11. The quantum computing system of claim 10, wherein the performing phase arithmetic is performed without using a repeat-until-success process or circuit.

12. The quantum computing system of claim 10, wherein the phase arithmetic comprises a smooth multi-variable function.

13. The quantum computing system of claim 10, wherein the phase arithmetic comprises a multiplication function of two phases.

14. The quantum computing system of claim 10, wherein the phase arithmetic comprises a multiplication function of a phase with a fixed real number.

15. The quantum computing system of claim 10, wherein phase estimation is used to output the phase as a bit string.

16. The quantum computing system of claim 10, wherein the function to be computed represents the classification output by a quantum neural network.

17. The quantum computing system of claim 10, wherein the functions computed represent part of or the entirety of the kinetic or potential energy of a quantum system within a quantum simulation.

18. A method comprising: using (a) linear combinations of unitary methods to implement arithmetic functions, other than addition, of more than one variable in phase in a quantum computing device; (b) linear combinations of unitary methods to implement arithmetic functions over more than one variable in phase in the quantum computing device using Fourier series approximations; or (c) linear combination of unitary methods in the quantum computing device to implement a fractional query of a diagonal phase oracle which outputs a range of phases.

19. The method of claim 18, wherein the method comprises using (a) or (b) to implement generic smooth functions of many variables in phase on the quantum computing device.

20. The method of claim 18, wherein the method comprises using (c).
